(19) United States
(12) Patent Application Publication
(10) Pub. No.: US 2010/0287534 A1
(43) Pub. Date: Nov. 11, 2010

(54) TEST CASE ANALYSIS AND CLUSTERING

(75) Inventors: Vipindeep Vangala, Hyderabad (IN); Phani Kishore Talluri, Hyderabad (IN); Jacek A. Czerwonka, Sammamish, WA (US); Sarada Prasanna Samantaray, Hyderabad (IN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/436,782

(22) Filed: May 7, 2009

(51) Int. Cl. G06F 9/44

(52) U.S. Cl. 717/124; 717/130

(57) ABSTRACT

Test suites can be optimized for more efficient software testing. A software program is instrumented and test cases of a test suite are run against the instrumented target binaries. A set of metrics are identified that can be used to capture a test case's execution and behavior and allow pairs of test cases of a test suite to be compared in a quantifiable manner. Metric values for test case pairs are generated and combined to create one or more unique signature values. Signature values are compared to cluster analogous test cases, allowing for, e.g., the association of comparable test cases, the identification of redundant test cases, and the formation of a test suite subset that can effectively test under time constraints.

### BACKGROUND

Test suites for testing and validating software programs can contain large numbers of test cases to execute various parts of the software program code to check for defects and code compliance. The general size of a test suite can vary from hundreds of test cases to more than a million for large and/or evolved software programs. Thus, test execution can take a great deal of time to complete. Additionally, test cases are often developed at different times and/or by different developers and thus one or more test cases in a test suite may be redundant in that they execute the same code paths for the same or similar data sets. Moreover, as the software program is updated and modified test cases in a test suite can become duplicative and/or superfluous.

Thus, it would be advantageous to identify and eliminate redundant test cases in a test suite, allowing a reduction in the test suite size which, in turn, can decrease testing time and contribute to optimizing maintenance efforts for the test suite. Further, it would be advantageous to perform test suite clustering or automatic bucketing of test cases based on a defined similarity level. Using clustering, the number of test cases to be executed for any particular test run can be limited, and even minimized, to accommodate test suite execution time constraints. Test case clustering can support an identification of a minimal set of test cases that maximizes test coverage of the software program while minimizing the number of tests to be run.

Additionally, it would be advantageous to estimate the effectiveness of a new test for a test suite while the test is being designed. It would also be beneficial to identify existing test cases that are similar to a new test case being developed. An existing similar test case can be used as a starting point for the design of the new test case, allowing for more efficient test case development.

Thus, it would be desirable to design a system and methodology for test case analysis and clustering that can be installed and/or operate on computers and computing-based devices, collectively referred to herein as computing devices.

### SUMMARY

This summary is provided to introduce a selection of concepts in a simplified form that are further described below in the Detailed Description. This summary is not intended to identify key or essential features of the claimed subject matter, nor is it intended to be used as an aid in determining the scope of the claimed subject matter.

Embodiments discussed herein include systems and methodology for test case analysis and clustering. In embodiments test cases of a test suite are executed on the target software code and test execution profiles are gathered for analysis. In embodiments metric values for a group of defined measurements are calculated for each test case pair in the test suite using the test profile data. In embodiments the metric values for a test case pair are combined into one or more signature values for the test case pair. In embodiments the signatures for each test case pair are used to cluster test case pairs that are identical, redundant or similar for purposes of, e.g., optimizing test suite execution and reducing test suite size.

In embodiments a pivot test case that is a superset of the test cases of a cluster is identified for each cluster. In these embodiments the set of pivot test cases can be executed to minimize testing time while ensuring the desired fault detection capability required of the test suite.

In embodiments existing test cases can be compared with test cases under design to identify, if existent, a test case to be the starting point for the test case under design. In these embodiments test case design can be faster and more efficient and a more concise, effective test suite can be maintained.

### BRIEF DESCRIPTION OF THE DRAWINGS

These and other features will now be described with reference to the drawings of certain embodiments and examples which are intended to illustrate and not to be limiting, and in which:

FIGS. 1A-1C depicts an embodiment logic flow for test case analysis, comparison, clustering, prioritization, and redundancy identification.

FIG. 2 illustrates exemplary test case pair similarity scenarios.

FIG. 3 depicts exemplary metrics for use in generating test case pair signatures.

FIGS. 4A-4C illustrate exemplary execution flows for a software under test.

FIG. 5 illustrates an example of an embodiment first metric for use in deriving a signature for a test case pair.

FIG. 6 illustrates an example of an embodiment second metric for use in deriving a signature for a test case pair.

FIG. 7 illustrates an example of an embodiment third metric for use in deriving a signature for a test case pair.

FIGS. 8A-8B illustrate an example of an embodiment fourth metric for use in deriving a signature for a test case pair.

FIG. 9 illustrates an example of an embodiment fifth metric for use in deriving a signature for a test case pair.

FIG. 10 illustrates an example of an embodiment sixth metric for use in deriving a signature for a test case pair.

FIG. 11A is an exemplary table of signature values for pairs of test cases of a test suite.

FIG. 11B is a clustering example for a test suite of seven test cases.

FIG. 11C is an embodiment pseudo code for generating optimal clusters of test cases of a test suite using test case pair signatures.

FIGS. 12A-12F illustrate an embodiment logic flow for generating optimal clusters of test cases of a test suite using test case pair signatures.

FIG. 13 is a block diagram of an exemplary basic computing device system that can process software, i.e., program code, or instructions.

### DETAILED DESCRIPTION

In the following description, for purposes of explanation, numerous specific details are set forth in order to provide a thorough understanding of embodiments described herein. It will be apparent, however, to one skilled in the art that the embodiments may be practiced without these specific details. In other instances well-known structures and devices are shown in block diagram form in order to avoid unnecessarily obscuration. Any and all titles used throughout are for ease of explanation only and are not for any limiting use.

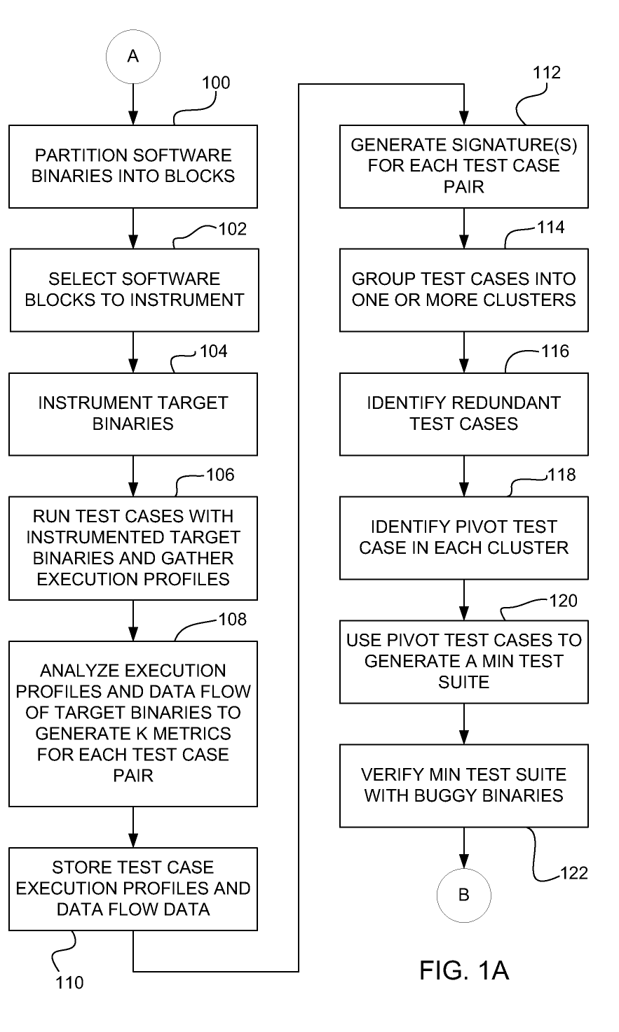

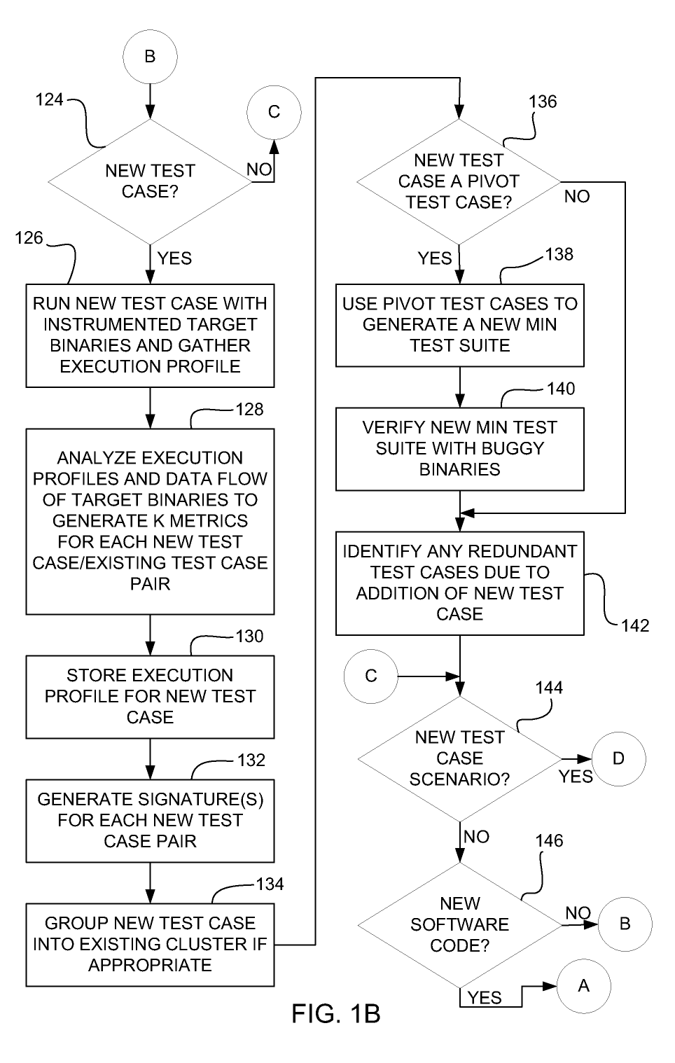

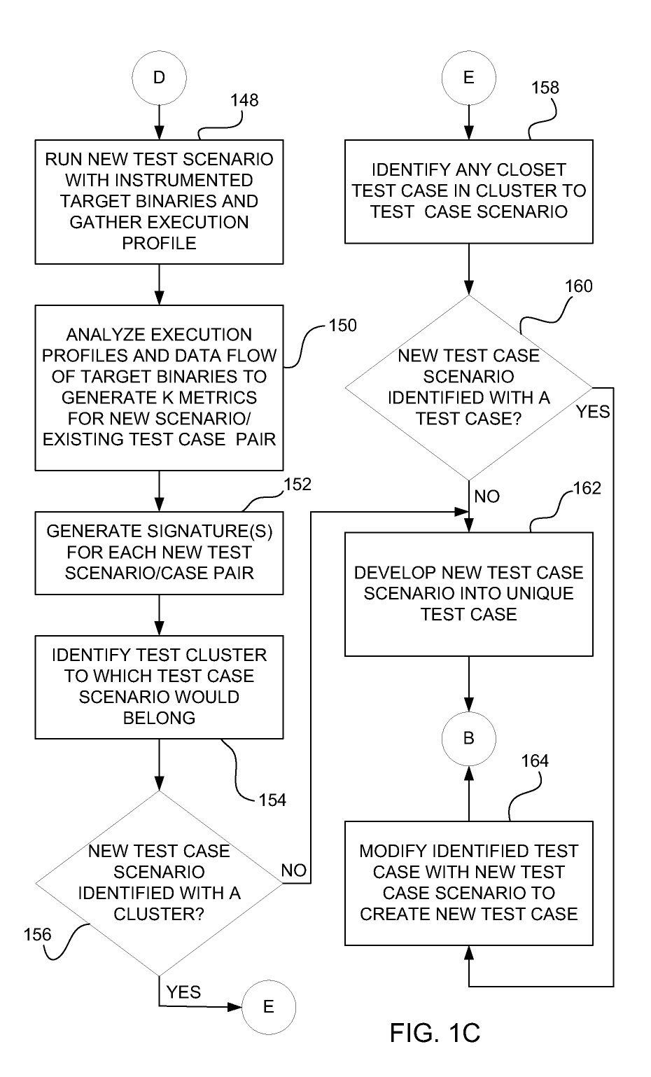

FIGS. 1A-1C illustrate an embodiment logic flow for test case analysis, comparison, clustering, prioritization, and redundancy identification. While the following discussion is made with respect to systems portrayed herein the operations described may be implemented in other systems. Further, the operations described herein are not limited to the order shown. Additionally, in other alternative embodiments more or fewer operations may be performed.

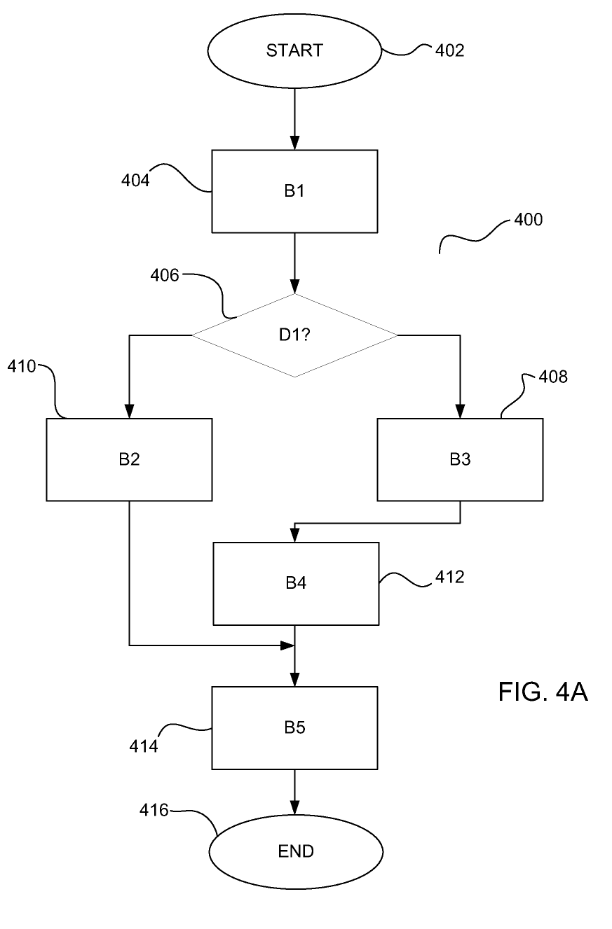

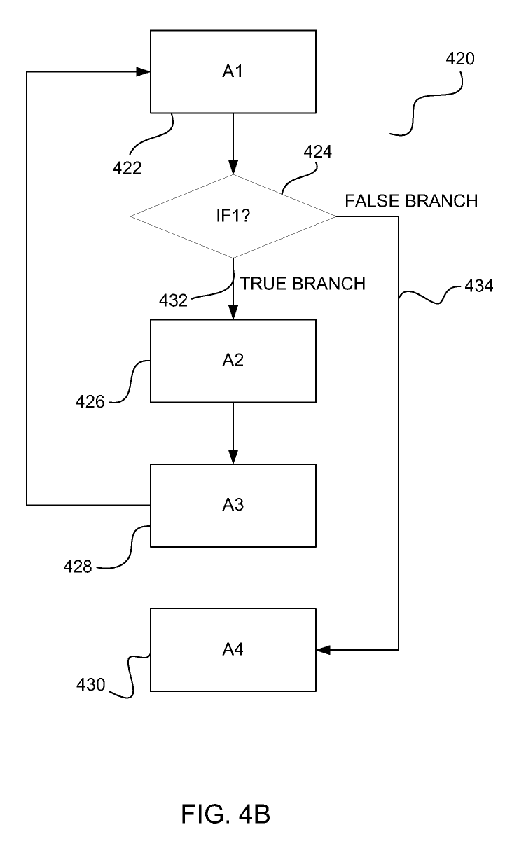

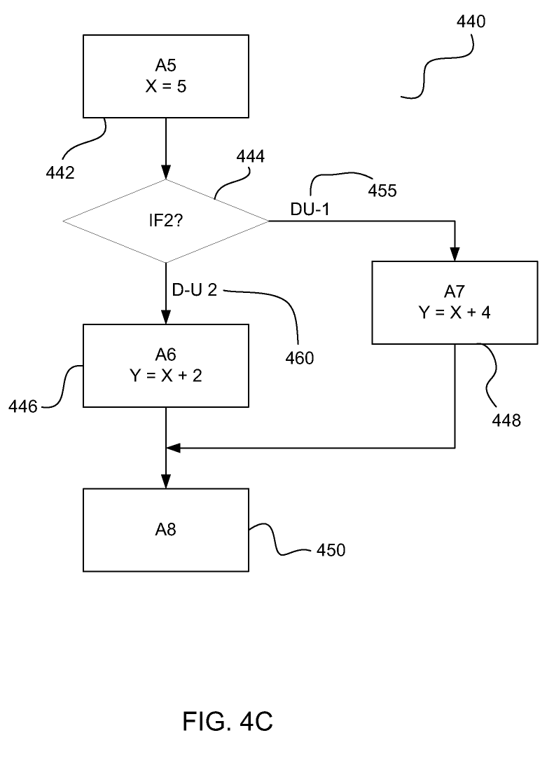

A test suite has one or more test cases designed to validate various features, paths, logic, etc. of a software program, or code, also referred to herein as the software code under test or the software binaries. Referring to FIG. 1A, in an embodiment the software binaries are partitioned into blocks 100. In an embodiment a block has a start, end and an execution flow. FIG. 4A is an example software code under test segmented into 5 blocks, B1 404, B2 410, B3 408, B4 412, and B5 414. FIG. 4B is an example logic flow for block B3 408 of FIG. 4A. In an embodiment a block has one entry, start, point and one exit, ending, point.

Referring again to FIG. 1A, one or more blocks are selected to be instrumented 102 and the selected blocks, or target binaries, are instrumented 104. In an embodiment an instrumented target binary supports the capture of execution flow information for test cases validating the target binary.

In an embodiment test cases of a test suite are run against the instrumented target binaries and execution profiles are gathered 106. In an embodiment an execution profile includes information about the execution flow of a test case with a target binary.

In an embodiment an analysis is performed on the gathered execution profiles and the data flow of the target binaries to generate k metrics for each test case pair 108. In an embodiment the k metrics are used to compare any two test cases of a test suite in a quantifiable manner.

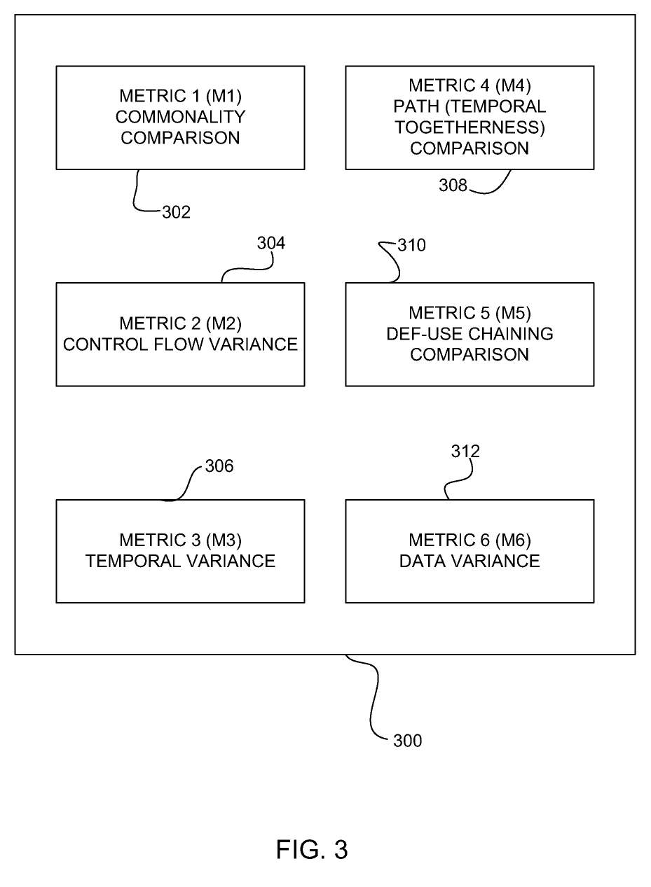

In an embodiment k is six (6). Referring to FIG. 3, in an embodiment a set of six (6) metrics 300 is used for analyzing, comparing, clustering, and prioritizing the test cases of a test suite. In an embodiment the selection of the k equals six (6) metrics is based on each metric's ability to capture a test case's execution and behavior with the target binaries.

In an embodiment a first metric M1 302 is a commonality comparison which measures block testing overlap between two test cases of a test suite. In an embodiment a second metric M2 304 is a control flow variance which captures the similarity of two test cases that test the same blocks that have conditional paths within them. In an embodiment a third metric M3 306 is a temporal variance which measures block testing overlap within the same time interval between two test cases of a test suite.

In an embodiment a fourth metric M4 308 is a path, or temporal togetherness, comparison that identifies the similarity of two test cases verifying the same block combinations in the same time interval. In an embodiment a fifth metric M5 310 is a def-use (definition/use) chaining comparison that measures def-use chain testing overlap between two test cases of a test suite. In an embodiment a sixth metric M6 312 is a data variance which measures the similarity of two test cases with respect to the data values they are using for variables in the software code under test.

In alternative embodiments more (k>6), less (k<6) and/or different metrics can be used for analyzing, comparing, clustering, and prioritizing the test cases of a test suite. In an alternative embodiment for example, a program slice chaining metric is used in calculating test case pair signatures where the program slicing extends the identification of def-use chains to external functionality that affects the outcome of a particular variable value.

In an embodiment a value for each metric is generated for each test case pair in a test suite. Thus, for example, if a test suite has three (3) test cases, T1, T2 and T3, a value for each metric will be generated for each of the test case pairs T1/T2, T1/T3 and T2/T3.

Referring again to FIG. 1A, in an embodiment the test case execution profiles and data flow data are stored 110.

In an embodiment two signatures are generated for each test case pair 112 in a test suite. In an embodiment each signature for a test case pair is a weighted average of a subset of the k metric values for the test case pair. In an alternative embodiment a signature is generated for each test case pair 112 in a test suite. In an aspect of this alternative embodiment the signature for a test case pair is a weighted average of normalized values of the k metric values for the test case pair. In other aspects of this alternative embodiment the signature for a test case pair is calculated using other algorithms involving one or more of the k metric values for the test case pair. In still other alternative embodiments other numbers of signature values, e.g., three (3), four (4), etc., can be generated for each test case pair 112.

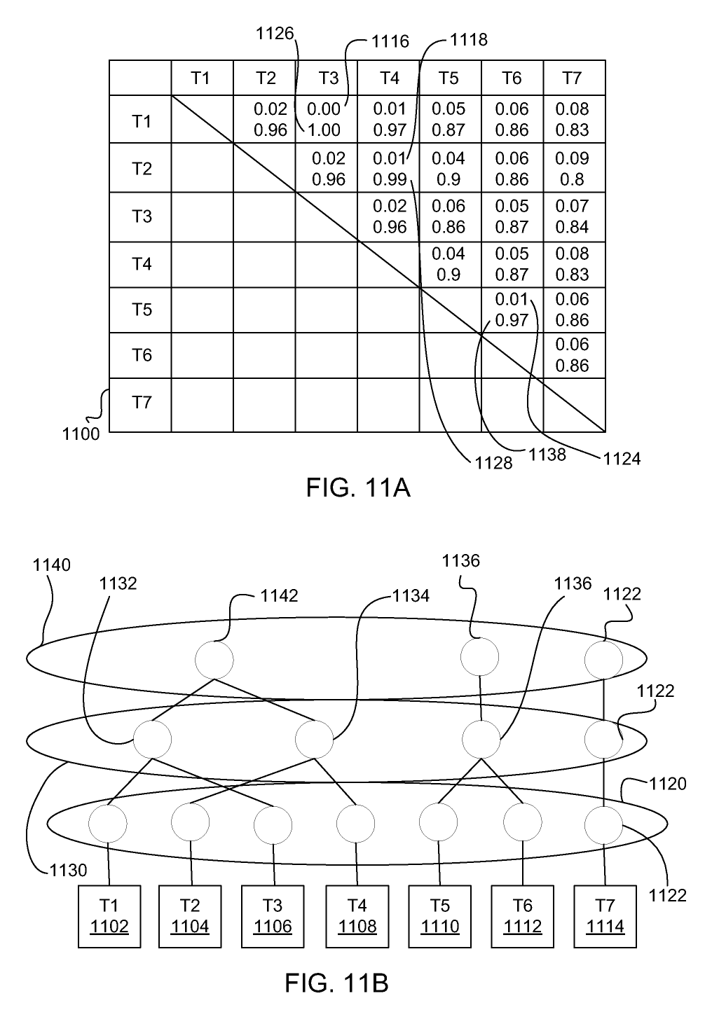

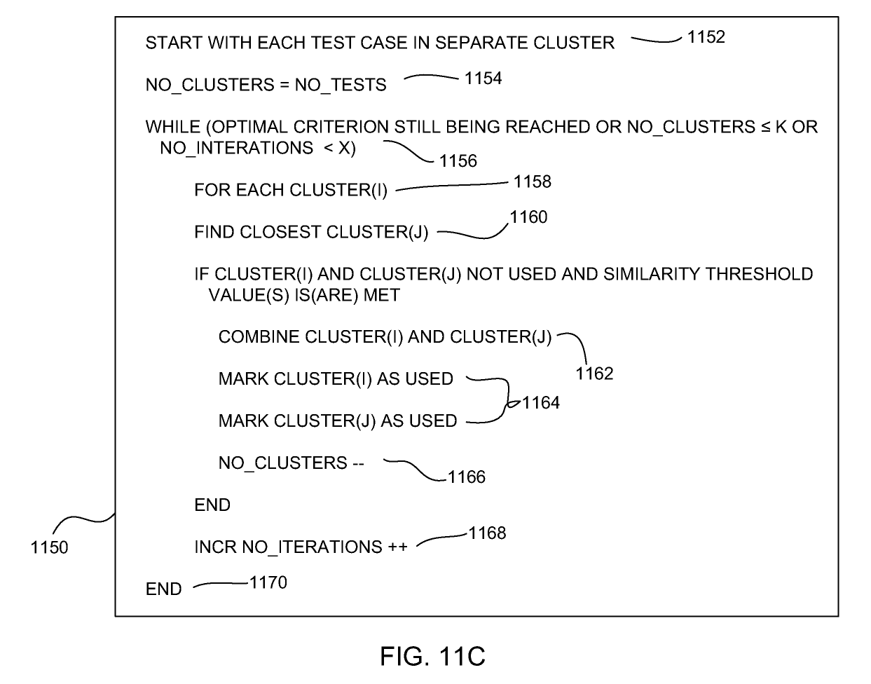

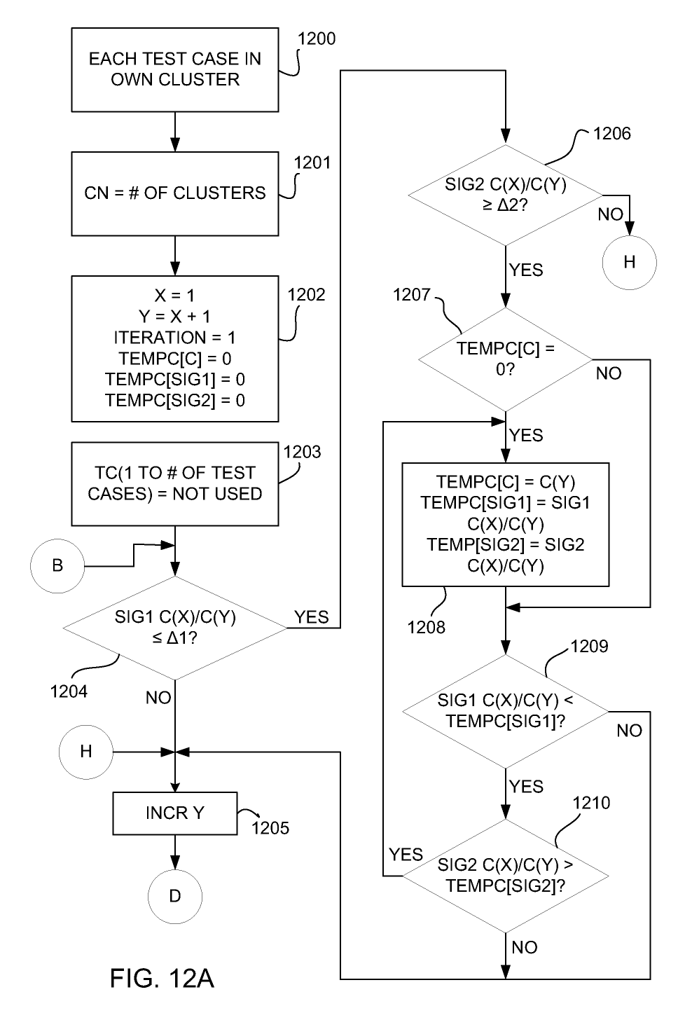

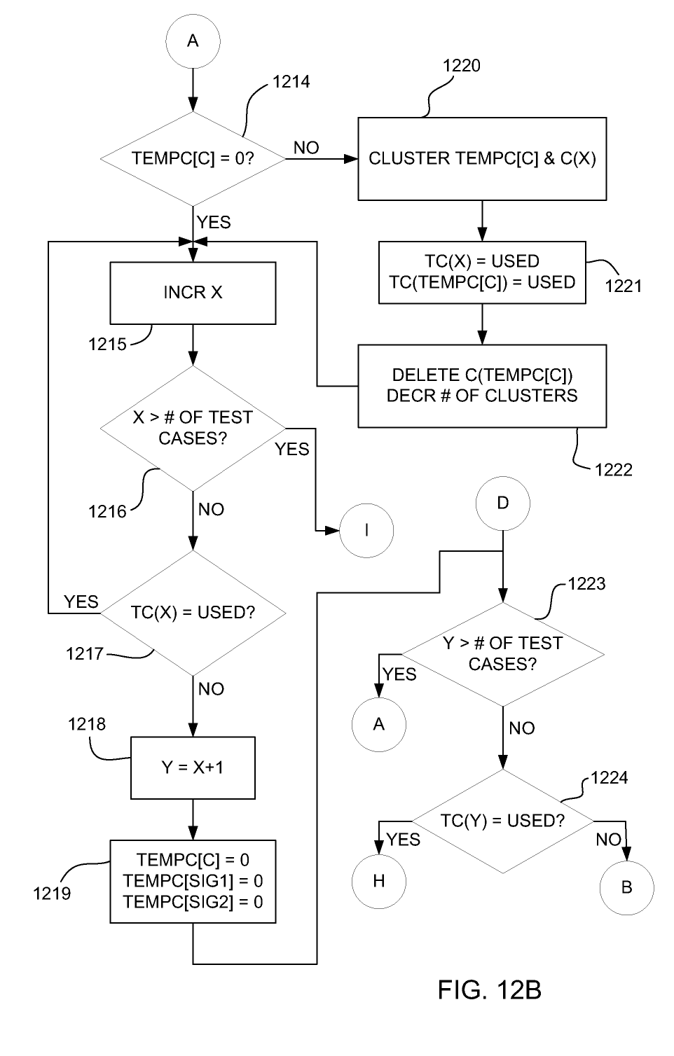

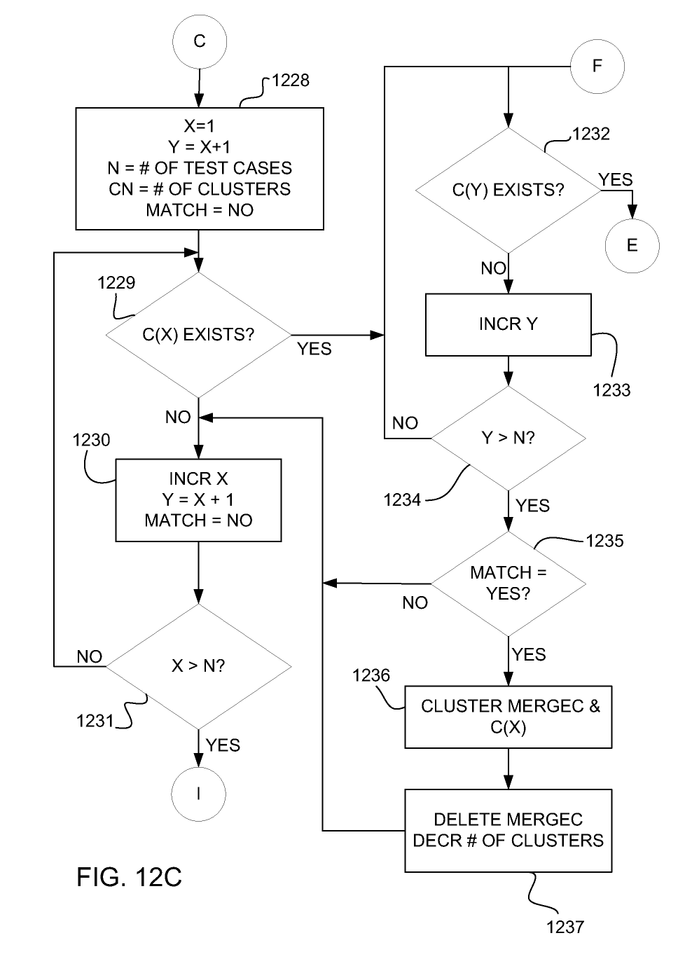

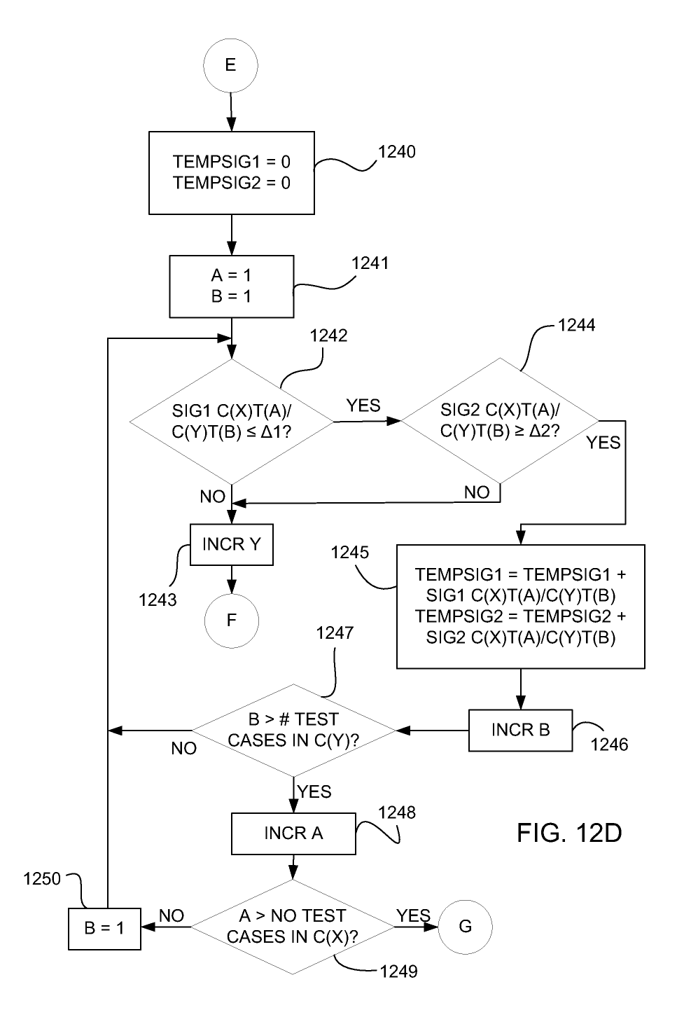

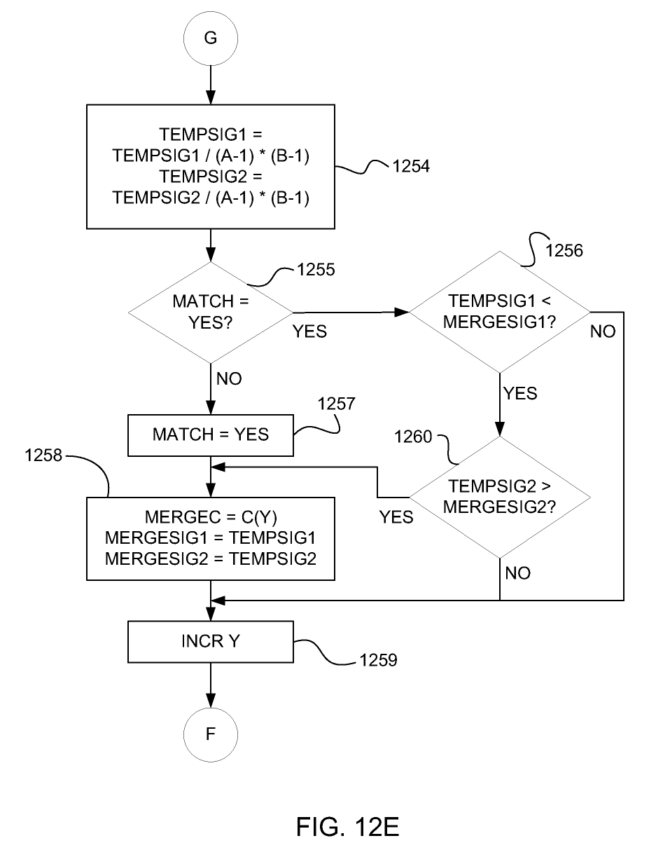

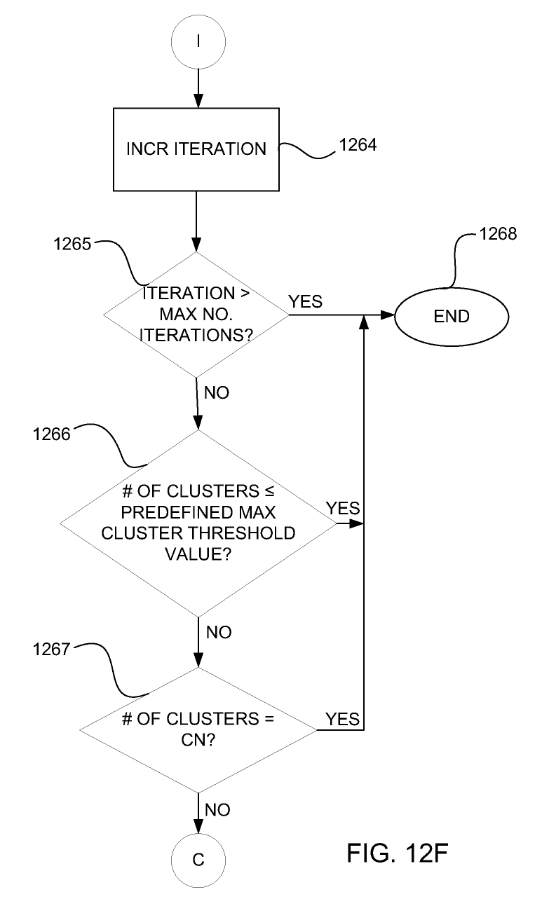

In an embodiment test cases are grouped into one or more clusters 114. In an embodiment the clusters are formed by a comparison of the signatures of the test case pairs of a test suite. In an embodiment agglomerative hierarchical clustering used in document clustering is applied to test case clustering for a test suite. Embodiment test case clustering is further described below with regards to FIGS. 11A through 11C and FIGS. 12A through 12F.

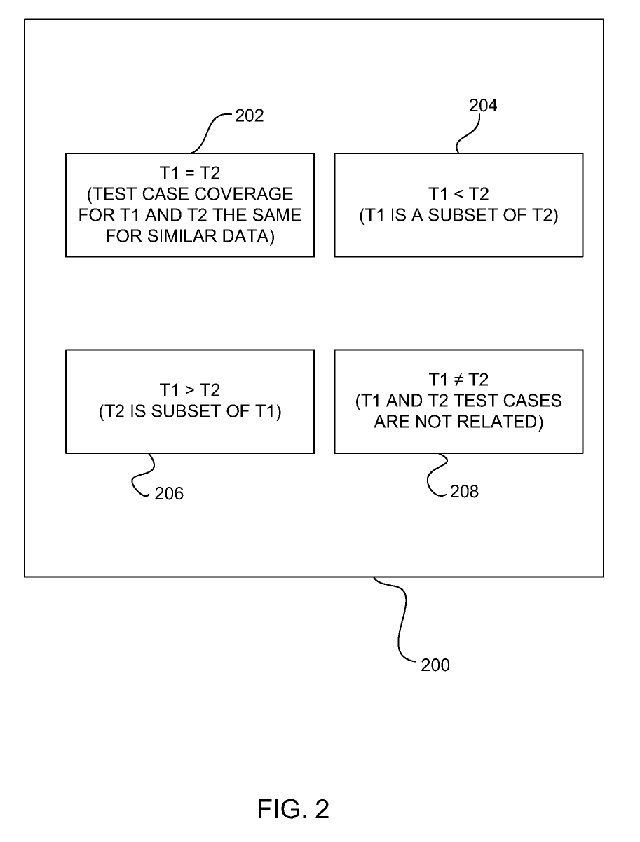

In an embodiment clustering combines test cases into groups based on their similarity to one another as measured by the signatures of the test case pairs of a test suite. Referring to FIG. 2, in an embodiment there are four possible similarity scenarios 200 for any test case pair of a test suite. In a first scenario 202, two test cases, e.g., test cases T1 and T2, are equal, meaning their test case coverage is the same for same or similar data.

In a second scenario 204 a first test case, e.g., T1, is a subset of a second test case, e.g., T2. In this second scenario 204 T1 is subsumed by T2 and T2 is a superset of T1.

In a third scenario 206 the second test case, e.g., T2, is a subset of the first test case, e.g., T1. In this third scenario 206 T2 is subsumed by T1 and T1 is a superset of T2.

In the first 202, second 204 and third 206 similarity scenarios, there is test case redundancy. Thus, in the second scenario 204 and the third scenario 206 the subsumed test case, T1 in scenario 204 and T2 in scenario 206, can be ignored or otherwise not used. In the case of the first scenario 202 either of the two test cases of the test case pair can be ignored or otherwise not used.

In a final, fourth, similarity scenario 208 the test cases of a test pair are not related in that one test case is not redundant and completely subsumed by the other test case. In this fourth scenario 208, however, the test cases of a test case pair may be similar enough to be clustered, or otherwise grouped, together.

In an embodiment a first, variance, threshold value and a second, commonality, threshold value are established to denote the level of sensitivity, or similarity, required for test case clustering. In an embodiment a cluster will contain the test cases of a test suite whose first test case pair signatures are less than or equal to the variance threshold value and whose second test case pair signatures are greater than or equal to the commonality threshold value. In an embodiment a rigid variance threshold value is zero (0.0) and a rigid commonality threshold value is one (1), both requiring that clustered test cases fall within the first scenario 202 of FIG. 2.

In an embodiment a normal variance threshold value is two one-hundreds (0.02) and a normal commonality threshold value is ninety-five one-hundreds (0.95). Using the normal variance and commonality threshold values test case pairs within the first 202, second 204 and third 206 scenarios of FIG. 2 will be clustered together and in some circumstances test case pairs within the fourth scenario 208 may also be clustered together.

In an embodiment a relaxed variance threshold value is five one-hundreds (0.05) and a relaxed commonality threshold value is nine-tenths (0.9). Using the relaxed variance and commonality threshold values test case pairs within the first 202, second 204, third 206 and fourth 208 scenarios of FIG. 2 may be clustered together.

In an embodiment other measures can be used for the variance and commonality threshold values and/or can signify the level of sensitivity, i.e., rigid, normal, relaxed, required for clustering. In an embodiment the threshold values are configurable. Thus, in embodiments the variance and commonality threshold values can be adjusted based on a user's needs, e.g., the threshold values can be relaxed to identify a smaller set of test cases necessary to be run in time constrained circumstances.

Referring again to FIG. 1A in an embodiment redundant test cases, e.g., the test cases falling within the first scenario 202 of FIG. 2, are identified 116. As noted, in an embodiment one test case of a redundant pair of test cases can be ignored or otherwise not used. In an embodiment if two test cases are redundant additional factors are used to identify the test case to be ignored or otherwise not used. In an embodiment one such additional factor is the execution time for the redundant test cases. Using this first additional factor, in an embodiment the redundant test case with the greater execution time will not be used. In an embodiment a second additional factor is the test case type, i.e., manual or automatic. Using this second additional factor, if one redundant test case of a test case pair is manual and the second test case is automatic, in an embodiment the first, manual, test case will not be used.

In an embodiment a pivot test case is identified for each cluster 118. In an embodiment a pivot test case is the test case of a cluster with the broadest test coverage within the cluster. Thus, in an embodiment the pivot test case is a superset of or similar to all the other test cases in the cluster. In an embodiment metric values and test case pair signatures are used to identify the pivot test case of a cluster 118. In an embodiment additional factors, e.g., test case execution time, test case type, etc., can be used to identify the pivot test case of a cluster 118.

In an embodiment the pivot test case of each cluster is used to generate a minimum test suite 120. In an embodiment the minimum test suite is verified against buggy binaries of the software code under test 122. In an embodiment buggy binaries are software binary versions that have bugs, or faults, in them in previous code builds which were corrected in subsequent code builds. Just as with the entire test suite, the buggy binaries are used to ensure that the minimum test suite can identify these same bugs. In an embodiment the minimum test suite must satisfy complete block, predicate and arc coverage while identifying all the bugs, or errors, in the software code under test that the test suite itself can discover.

In an embodiment a block is a set of contiguous code, or instructions, in the physical layout of a target binary that have exactly one entry point and one exit point. In this embodiment calls, jumps and branches mark the end of a block. In embodiments a block generally consists of multiple instructions. In an embodiment predicate coverage refers to test coverage of all the branches of conditional, e.g., true/false, instructions. In an embodiment the arc of a block refers to all possible execution paths through the block.

Referring to FIG. 1B, in an embodiment at decision block 124 a determination is made as to whether there is a new test case for the test suite. If yes, in an embodiment the new test case is run against one or more of the instrumented target binaries and an execution profile for the new test case is gathered 126. In an embodiment the execution profile for the new test case includes information about the execution flow of the new test case with the target binaries.

In an embodiment an analysis is performed on the execution profile of the new test case and the data flow of the target binaries to generate k metrics for each new test case/test case pair 128. In an embodiment the new test case is compared with each existing test case of the test suite.

In an embodiment the newly generated execution profile for the new test case is stored 130.

In an embodiment two signatures are generated for each new test case/test case pair 132 using the k metrics generated for each new test case/test case pair. In an embodiment each signature for a new test case/test case pair is a weighted average of a subset of the k metrics for the new test case/test case pair.

In an embodiment the new test case is grouped into its own, new, cluster, or is grouped into an existing cluster, as appropriate 134. In an embodiment the cluster determination for the new test case is made using a comparison of the signatures of the new test case/test case pairs. In an embodiment clustering assigns the new test case to a cluster based on the new test case's similarity to other test cases in the test suite as measured by the signatures of the test case pairs of the test suite. Embodiment test case clustering is further described below with regards to FIGS. 11A through 11C and FIGS. 12A through 12F.

In an embodiment at decision block 136 a determination is made as to whether the new test case is a pivot test case of its assigned cluster. In an embodiment metric values and test case pair signatures are used to identify the pivot test case of a cluster. In an embodiment additional factors, e.g., test case execution time, test case type, etc., can be used in identifying the pivot test case of a cluster.

If the new test case is a pivot test case of its assigned cluster then in an embodiment the new set of pivot test cases are used to generate a new minimum test suite 138. In an embodiment the new minimum test suite is verified against buggy binaries of the software code under test 140.

Whether or not the new test case is a pivot test case of its assigned cluster, in an embodiment any test cases that are now redundant due to the addition of the new test case to the test suite are identified 142.

At decision block 144 a determination is made as to whether there is a new test case scenario, i.e., a new test case to be generated. If no, in an embodiment at decision block 146 a determination is made as to whether there is new software code under test, e.g., an update to the software code under test. If yes, and referring to FIG. 1A, in an embodiment the new software code under test is partitioned into blocks 100, one or more new blocks are selected to be instrumented 102 and the selected target binaries are instrumented 104.

If at decision block 146 it is determined that that there is no new software code under test then in an embodiment processing flow returns to decision block 124 where it is determined if there is a new test case being added to the test suite.

If at decision block 144 it is determined that there is a new test case scenario then in an embodiment, and referring to FIG. 1C, the new test case scenario is run with the instrumented target binaries and an execution profile for the new test scenario is gathered 148.

In an embodiment an analysis is performed on the execution profile of the new test case scenario and the data flow of the target binaries to generate k metrics for each new test case scenario/test case pair 150. In this embodiment the new test case scenario is compared with each existing test case of the test suite.

In an embodiment two signatures are generated for each new test case scenario/test case pair 152 using the k metrics generated for each new test case scenario/test case pair. In an embodiment each of the two signatures for a new test case scenario/test case pair is a weighted average of a subset of the k metrics for the new test case scenario/test case pair.

In an embodiment the new test case scenario is grouped into its own, new, cluster, or is grouped into an existing cluster, as appropriate 154. In an embodiment the cluster determination for the new test case scenario is made using a comparison of the signatures of the new test case scenario/test case pairs. In an embodiment at decision block 156 a determination is made as to whether the new test case scenario is assigned to a cluster that has existing test cases. If no, the new test case scenario is unique and in an embodiment the new test case scenario is developed into a unique new test case for the test case suite 162.

If at decision block 156 it is determined that the new test case scenario is assigned to a cluster with existing test cases then in an embodiment the closest, i.e., most similar, test case in the cluster to the test case scenario is identified, if possible, 158. In an embodiment at decision block 160 a determination is made as to whether or not a similar enough existing test case exists for the new test case scenario. If no, the new test case scenario is unique enough and in an embodiment the new test case scenario is developed into a unique new test case for the test case suite 162.

If at decision block 160 it is determined that there is a similar enough existing test case for the new test case scenario then in an embodiment the identified similar existing test case is modified to incorporate the new test case scenario 164 and a new test case is created that includes the original testing and the new scenario testing.

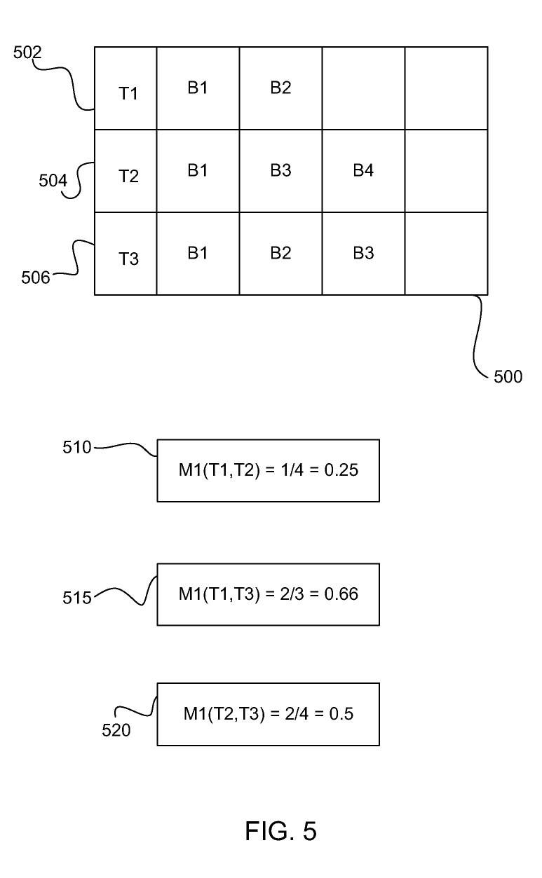

As noted, in an embodiment k metrics are determined for each test case pair in a test suite. In an embodiment k is six (6). Referring to FIG. 3, in an embodiment a first metric, M1, 302 is a commonality comparison that measures block testing overlap between two test cases in a test suite. FIG. 5 is an example for generating an M1 metric 302 value for three exemplary tests, T1 502, T2 504, and T3 506, of a test suite. Chart 500 depicts exemplary block executions for each of tests T1 502, T2 504 and T3 506. In the example of FIG. 5 test T1 502 executed blocks B1 and B2 of an exemplary software code under test, e.g., software code 400 of FIG. 4A. In the example of FIG. 5 test T2 504 executed blocks B1, B3 and B4 of the exemplary software code under test and test T3 506 executed blocks B1, B2 and B3.

In an embodiment the M1 metric 302 is calculated by adding the number of common blocks tested by a test case pair and dividing this sum by the total number of unique blocks tested by both test cases of the pair. In an embodiment the M1 metric 302 has no notion of sequencing or timing and for this metric there is no requirement that the test cases of the pair execute the common blocks in the same order or the same time frame.

Equation 510 of FIG. 5 is an exemplary calculation for the M1 metric 302 for the test case pair T1/T2. In the example of FIG. 5 T1 502 and T2 504 both execute the B1 block and the B1 block is the only block executed by both of them. Thus the numerator for the M1 metric 302 for the T1/T2 test case pair is one (1). In this example T1 502 and T2 504 execute a total of four (4) unique blocks: B1, B2, B3 and B4. Thus the denominator for the M1 metric 302 for the T1/T2 test case pair is four (4) and the M1 metric 302 value for the T1/T2 test case pair is one (1) divided by (4) or twenty-five one-hundreds (0.25).

Equation 515 of FIG. 5 is an exemplary calculation for the M1 metric 302 for the test case pair T1/T3. In the example of FIG. 5 T1 502 and T3 506 both execute code blocks B1 and B2 and T3 506 also executes code block B3. Thus the numerator for the M1 metric 302 for the T1/T3 test case pair is two (2) as T1 502 and T3 506 execute two common blocks: B1 and B2. The denominator for the M1 metric 302 for the T1/T3 test case pair is three (3) as T1 502 and T3 506 execute a total of three unique blocks: B1, B2 and B3. The resultant M1 metric 302 value for T1/T3 is two (2) divided by three (3), which equals two-thirds (⅔).

Equation 520 of FIG. 5 is an exemplary calculation for the M1 metric 302 for the test case pair T2/T3. In the example of FIG. 5 T2 504 and T3 506 both execute the B1 and B3 blocks, and thus the numerator for the M1 metric 302 for T2/T3 is two (2). In this example T2 504 and T3 506 execute a total of four (4) unique blocks: B1, B2, B3 and B4. The denominator for the M1 metric 302 for the T2/T3 pair is therefore four (4) and the M1 metric 302 value for T2/T3 is two (2) divided by four (4), which equals five tenths (0.5).

Referring to FIG. 3, in an embodiment a second metric, M2, 304 is a control flow variance which captures the similarity of two test cases that test the same blocks that have conditional paths within them. FIG. 4B depicts an exemplary instruction flow 420 for block B3 408 of FIG. 4A. The instruction flow 420 of FIG. 4B has a conditional, IF1, instruction 424 that has a true branch 432 and a false branch 434.

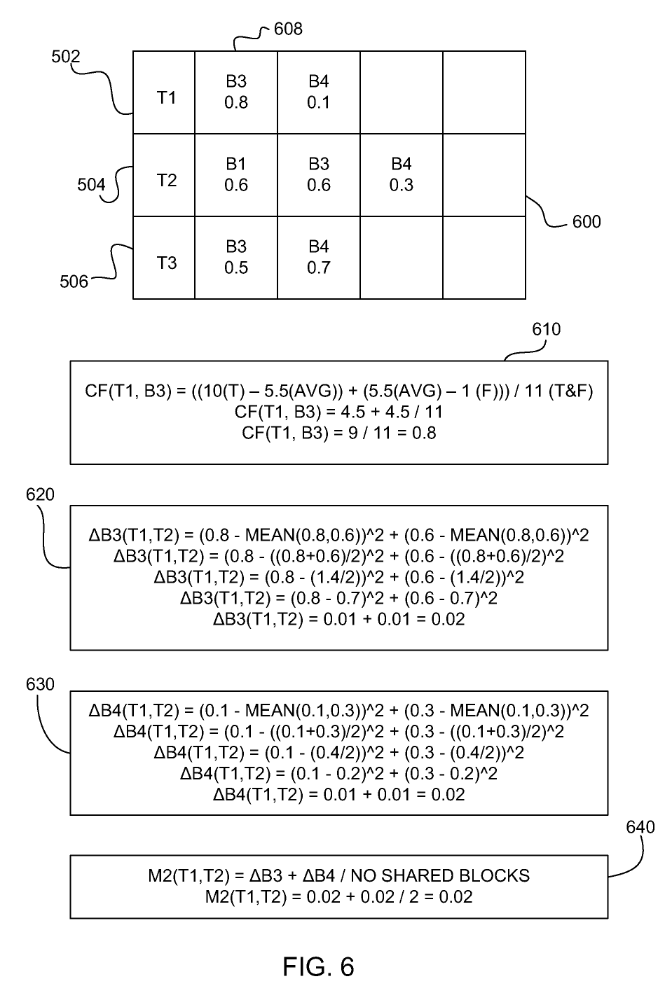

FIG. 6 is an example for generating an M2 metric 304 value for a test case pair. In FIG. 6 three exemplary tests, T1 502, T2 504, and T3 506, of a test suite have each executed blocks of a target binary, including block B3 408 of FIG. 4B. In an embodiment for each test case that executes a block with a conditional branch a control flow, CF, value is calculated that provides a measurement for the number of times the test case takes each conditional branch. Exemplary control flow, CF, values are depicted in chart 600 for target binary blocks executed by test cases T1 502, T2, 504 and T3 506. An exemplary CF value for test case T1 502 for block B3 is eight tenths (0.8) shown by entry 608 of the chart 600.

Referring to equation 610, as an example the control flow value, CF, is calculated for exemplary test case T1 502 for the conditional statement IF1 424 of block B3 408 in FIG. 4B. In an embodiment a numerator for a CF value is generated by subtracting the number of times each path of a conditional statement is executed by a test case with the average of the number of times each path of a conditional statement is executed by a test case, i.e., the average path value, and the result is summed for all conditional paths. In an embodiment the denominator for a CF value is the sum of the number of paths executed from a conditional statement by a test case.

Assume for this example that test case T1 502 executes the true branch 432 of the conditional statement IF1 424 ten (10) times and the false branch 434 one (1) time. The average number of times each path, true branch 432 and false branch 434, is executed is the sum of the number of times each branch is executed, ten (10) plus one (1), equal to eleven (11), divided by the number of branches, two (2). Thus the average number of times each path of the conditional statement IF1 424 is executed by T1 502, i.e., the average path value, is eleven (11) divided by two (2), which equals five and one half (5.5).

To calculate the CF value for T1 502, as shown in exemplary equation 610, the difference between the average path value (5.5) for T1 502 and the number of times each conditional path is executed by T1 502 is calculated and these values are summed to generate the CF numerator. In this example T1 502 executes the true branch 432 ten (10) times and the difference between the average path value (5.5) and the true branch executions (10) is four and one half (10−5.5=4.5). In this example T1 502 executes the false branch 434 one (1) time and the difference between the average path value (5.5) and the false branch executions (1) is also four and one half (5.5−1=4.5). Summing these two values (4.5+4.5) generates a value of nine (9) for the CF numerator for T1 502.

As noted, in an embodiment the CF denominator value is the sum of the number of times each conditional branch is executed by the test case. In the example of FIG. 6 T1 502 executes the true branch 432 ten (10) times and the false branch 434 one (1) time, and thus the CF denominator for T1 502 is eleven (10+1=11).

Dividing the CF numerator value (9) for T1 502 by its CF denominator (11) value results in an exemplary CF value of eight tenths (0.8) for T1 502, as shown in equation 610 and chart entry 608.

In an embodiment CF values are generated for each test case for each block with a conditional instruction executed by the test case. Chart 600 shows exemplary CF values for blocks B1, B3 and B4 of a software program executed by test cases T1 502, T2 504 and T3 506.

In an embodiment the M2 metric 304 value for a test case pair is calculated by adding the variance of CF values for common blocks with conditional statements executed by a test case pair and dividing by the number of common blocks with conditional statements executed by the test case pair.

Equation 640 of FIG. 6 is an exemplary calculation for the M2 metric 304 for the test case pair T1/T2. In the example of FIG. 6 T1 502 and T2 504 both execute blocks B3 and B4 and both blocks B3 and B4 have conditional statements. While T2 504 also executes the B1 block, T1 502 does not, and thus in an embodiment the CF value for T2 504 for block B1 does not affect the M2 metric 304 value for the T1/T2 test case pair

As shown in the embodiment example of equation 640 the M2 metric 304 value for T1/T2 is calculated by adding the variances of CF values for commonly executed blocks containing conditional statements and dividing by the number of commonly executed blocks containing conditional statements executed by the test case pair. Thus the M2 metric 304 value for the T1/T2 test case pair is the variance of the CF values for block B3, i.e., ΔB3, plus the variance of the CF values for block B4, i.e., ΔB4, divided by the number of commonly executed conditional statement blocks, two (2).

In an embodiment the variance of CF values for a block is calculated by subtracting the mean of the CF values for each test case for the block from each CF value for each test case in the test case pair, squaring the result and summing each of the squared results. In other embodiments other statistical computations that quantify the diversity between the CF values for a block for a test case pair are used.

Exemplary equation 620 shows an embodiment calculation for the variance of CF values for block B3 for the test case pair T1/T2, i.e., ΔB3(T1,T2). As shown in FIG. 6, the mean, or average, of the CF values for the B3 block for T1/T2 is calculated and then squared. In the example of FIG. 6, the mean of the CF values for block B3 for T1/T2 is the sum of the CF values for block B3 for T1 502 and T2 504, i.e., the sum of eight tenths (0.8) and sixth tenths (0.6) as shown in chart 600, divided by the number of summed values, i.e., two (2). The resultant mean value, seven tenths (0.7), is subtracted from each of the CF values for T1 502 and T2 504 for block B3, i.e., eight tenths (0.8) and six tenths (0.6). The results of the subtractions is then squared and summed, resulting in a variance of CF values for block B3 for T1/T2, i.e., ΔB3(T1,T2), of two one-hundreds (0.02).

Exemplary equation 630 shows an embodiment calculation for the variance of CF values for block B4 for the test case pair T1/T2, i.e., ΔB4(T1,T2). As shown in FIG. 6, the mean, or average, of the CF values for the B4 block for T1/T2 is calculated and then squared. In the example of FIG. 6, the mean of the CF values for the B4 block for T1/T2 is the sum of the CF values for block B4 for T1 and T2, i.e., the sum of one tenth (0.1) and three tenths (0.3) as shown in chart 600, divided by the number of summed values, i.e., two (2). The resultant mean value, two tenths (0.2), is subtracted from each of the CF values for T1 502 and T2 504 for block B4, i.e., one tenth (0.1) and three tenths (0.3). The results of the subtractions is then squared and summed, resulting in a variance of CF values for block B4 for T1/T2, i.e., ΔB4(T1,T2), of two one-hundreds (0.02).

Referring again to equation 640, the M2 metric 304 value for the T1/T2 test case pair is ΔB3(T1,T2), equal to two one-hundreds (0.02) in the example of FIG. 6, plus ΔB4(T1,T2), also equal to two one-hundreds (0.02) in this example, divided by the number of commonly executed conditional statement blocks, B3 and B4, which is two (2). Thus, in the example of FIG. 6 the M2 metric value for the T1/T2 test case pair, M2(T1,T2), is four one-hundreds (0.02+0.02=0.04) divided by two (2), which equals two one-hundreds (0.02).

Referring to FIG. 3, in an embodiment a third metric M3 306 is a temporal variance which measures block testing overlap within the same time interval between two test cases of a test suite. In an embodiment metric M3 306 is concerned with how many of the same blocks are executed in the same time interval by a test case pair.

In an embodiment when a test case is run a snapshot of the blocks of the target binaries that are executed by the test case is captured every n milliseconds. In an embodiment n is ten (10). In other embodiments n is other values, e.g., five (5), twenty (20), etc. In other embodiments snapshots of the target binaries being executed by a test case are captured in other time increments, e.g., once every second, once every two minutes, etc.

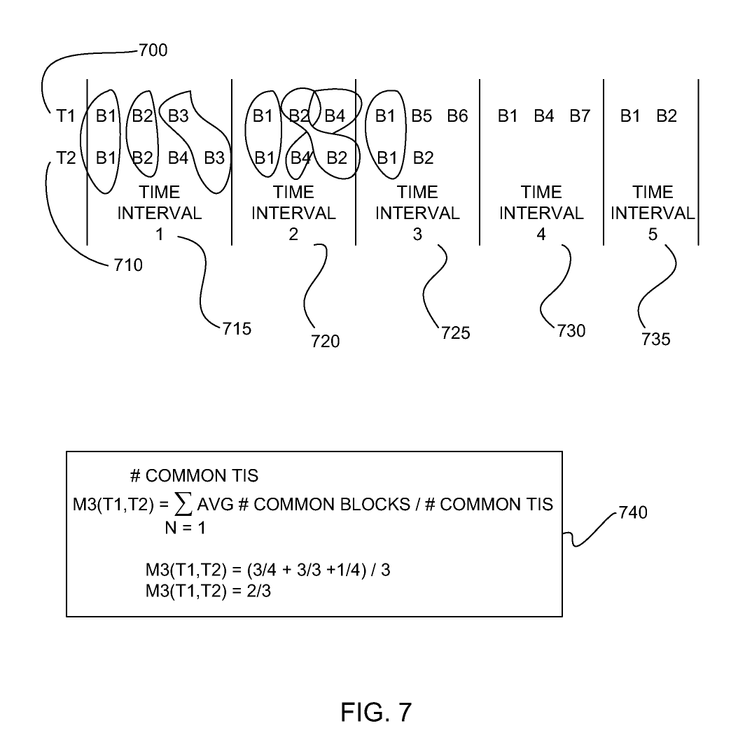

An exemplary snapshot recording 700 of block execution by an exemplary test case T1 502 for five (5) ten millisecond intervals of test case execution is shown in FIG. 7. An exemplary snapshot recording 710 of block execution by an exemplary test case T2 504 for three (3) ten millisecond intervals of test case execution is also depicted in FIG. 7.

In an embodiment the numerator of metric M3 306 is calculated by summing the number of common blocks tested by each test case in a pair for each time interval divided by the total number of unique blocks executed by both test cases in the time interval. In an embodiment common blocks do not have to be executed in the same order by a test case pair as long as they are executed in the same time interval. Thus, for example, block B3 is a common block for T1 502 and T2 504 for the first time interval 715 as both test cases execute the B3 block in this first time interval 715 even though they do not execute block B3 in the same order. As can be seen in the example of FIG. 7 T1 502 executes the B3 block after the B2 block in the first time interval 715 while T2 504 executes the B3 block after the B4 block in this same time interval 715.

In an embodiment the denominator of metric M3 306 is the number of common time intervals for the test case pair. In the example of FIG. 7, T1 502 and T2 504 execute in three common time intervals: T1 715, T2 720 and T3 725. As can be seen in the exemplary snapshot recording 700 T1 502 executes for an additional two time intervals, 730 and 735, than T2 504. In an embodiment, because these last two time intervals 730 and 735 are not common execution time intervals for the T1/T2 test case pair, they are not used for the M3 metric calculation for this test case pair. Thus, in the example of FIG. 7 the number of common time intervals used in the denominator for the M3 metric calculation for the T1/T2 test case pair is three (3).

In the example of FIG. 7 for the first time interval 715 T1 502 and T2 504 both execute blocks B1, B2 and B3. In this example for the first time interval 715 T2 504 also executes block B4. The number of commonly executed blocks for the first time interval 715 for the T1/T2 test case pair of this example is three (3). The total number of unique blocks executed by T1 502 and T2 504 in the first time interval 715 is four (4). Thus, as shown in equation 740, the first value for summing in the numerator for the M3 metric 306 for the T1/T2 test case pair is three (3) divided by four (4).

In the example of FIG. 7, for the second time interval 720 T1 502 and T2 504 both execute the same blocks B1, B2 and B4. Thus the number of commonly executed blocks for the second time interval 720 for the T1/T2 test case pair of this example is three (3). The total number of unique blocks executed by T1 502 and T2 504 in the second time interval 720 is also three (3). Thus, as shown in equation 740 the second value for summing in the numerator for the M3 metric 306 for the T1/T2 test case pair is three (3) divided by three (3).

For the example of FIG. 7 in the third, and last, common time interval 725 T1 502 and T2 504 both execute block B1. In this exemplary third time interval 725 T1 502 also executes blocks B5 and B6 and T2 504 also executes block B2. The number of commonly executed blocks, B1, for this third time interval 725 for the T1/T2 test case pair of this example is one (1). The total number of unique blocks executed by T1502 and T2 504 in this third time interval 725, B1, B2, B5 and B6, is four (4). Thus, as shown in equation 740 the third value for summing in the numerator for the M3 metric 306 for the T1/T2 test case pair is one (1) divided by four (4).

Summing the three numerator values for the M3 metric for the T1/T2 test case pair in equation 740 and dividing the result by the denominator value of three (3) results in an M3 metric value for the T1/T2 test case pair of two-thirds (⅔) for the example of FIG. 7.

Referring to FIG. 3, in an embodiment a fourth metric, M4 308, is a path, or temporal togetherness, comparison that identifies the similarity of two test cases verifying the same block combinations in the same time intervals.

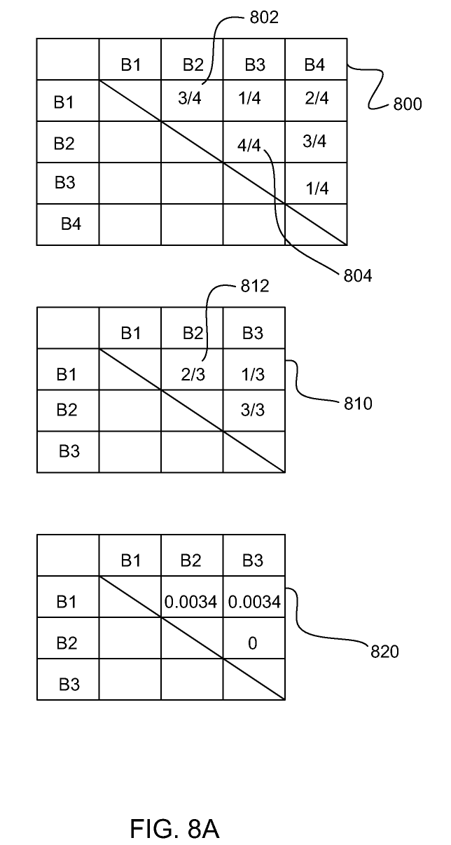

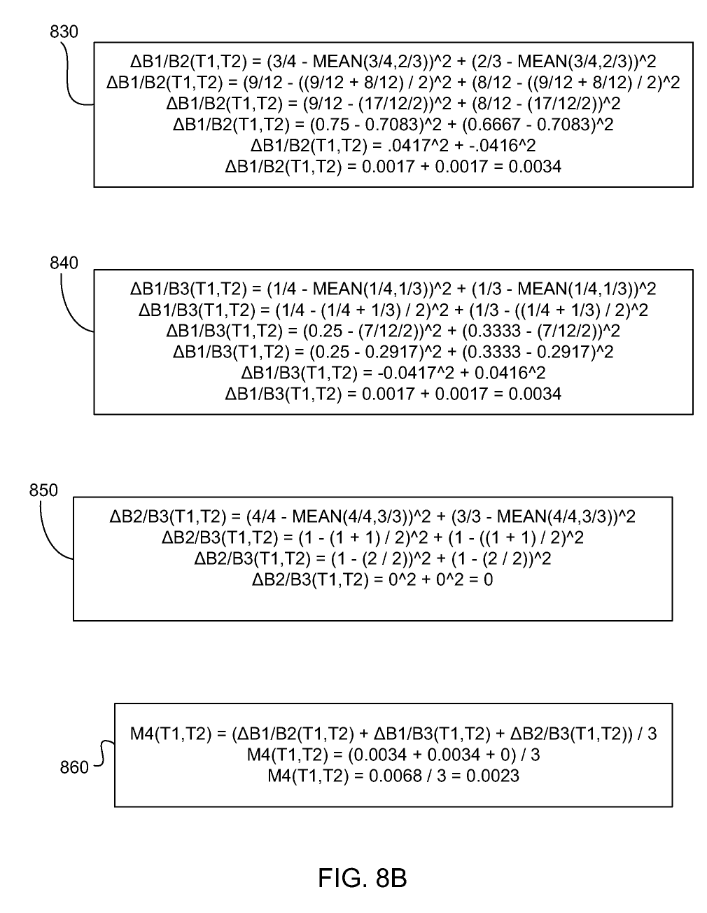

FIGS. 8A and 8B provide an example for generating an M4 metric 308 value for an exemplary T1/T2 test case pair. In an embodiment, for each test case a matrix is developed to identify for each block pair of the software code under test the percentage of time intervals the test case tested the block pair in the same time interval; i.e., denotes the block execution commonality for a test case. For example, referring to the first matrix 800 of FIG. 8A for test case T1502, entry 802, with an exemplary value of three-fourths (¾), indicates that T1 502 executed blocks B1 and B2 in three of the same four time intervals that T1 502 ran. As another example, entry 804 of matrix 800 has an exemplary value of four-fourths ( 4/4), indicating that T1 502 executed blocks B2 and B3 in all four of the four time intervals that T1 502 ran.

Exemplary matrix 810 identifies for each block pair of the software code under test the percentage of time intervals test case T2 504 tested the block pair in the same time interval.

In an embodiment the matrices are established to have one entry for each test block pair commonality. Thus, in an embodiment only half of each matrix for each test case is used as a fully populated matrix for any test case repeats block pair commonality.

As shown in the embodiment example of equation 860 of FIG. 8B the M4 metric 308 value for T1/T2 is calculated by adding variances of block execution commonality for block combinations for a test case pair and dividing by the number of commonly executed blocks executed by the test case pair. In the example of FIGS. 8A-8B, test case T1 502 and test case T2 504 execute three common blocks: B1, B2 and B3. Test case T1 502 also executes block B4 but in an embodiment, as test case T2 504 does not execute B4, block B4 is not figured in the calculation of the M4 metric value for T1/T2. Referring to equation 860 in an embodiment and the example of FIGS. 8A-8B the M4 metric 308 value for the T1/T2 test case pair is the variance of block execution commonality for the B1/B2 combination, i.e., ΔB1/B2, plus the variance of block execution commonality for the B1/B3 combination, i.e., ΔB1/B3, plus the variance of the block execution commonality for the B2/B3 combination, i.e., ΔB2/B3, divided by the number of commonly executed blocks, three (3).

In an embodiment the variance of block execution commonality for a block pair is calculated by subtracting the mean of the block execution commonality values for each test case for the block pair from each block execution commonality value for each test case in the test case pair, squaring the result and summing each of the squared results. In other embodiments other statistical computations that quantify the diversity between block execution commonality values for a block combination for a test case pair are used.

Exemplary equation 830 shows an embodiment calculation for the variance of block execution commonality for the B1/B2 combination for the test case pair T1/T2, i.e., ΔB1/B2(T1,T2). As shown in FIG. 8B, the mean, or average, of the block execution commonality values for the B1/B2 combination for T1/T2 is calculated and then squared. In the example of FIG. 8B the mean of the block execution commonality values for the B1/B2 combination for T1/T2 is the sum of the block execution commonality value for B1/B2 for T1502, i.e., entry 802 with a value of three-fourths (¾) of matrix 800 of FIG. 8A, and the block execution commonality value for B1/B2 for T2 504, i.e., entry 812 with a value of two-thirds (⅔) of matrix 810, divided by the number of summed values, i.e., two (2). The resultant mean value (0.7083) is subtracted from each of the block execution commonality values for T1 502 and T2 504 for the B1/B2 combination, i.e., three-fourths (¾) and two-thirds (⅔). The results of the subtractions (0.0417 and 0.0416 respectively) are then squared and summed, resulting in a variance of block execution commonality values for B1/B2 for T1/T2, i.e., ΔB1/B2(T1,T2), of thirty-four one-thousands (0.0034).

In an embodiment the same formula is used for calculating the variance of block execution commonality values for B1/B3 for T1/T2, i.e., ΔB1/B3(T1,T2) as shown in equation 840 of FIG. 8B, and for calculating the variance of block execution commonality values for B2/B3 for T1/T2, i.e., ΔB2/B3(T1,T2) as shown in equation 850 of FIG. 8B. The resultant exemplary variance values of block execution commonality values for the block combinations for T1/T2 are shown in matrix 820 of FIG. 8A.

Referring again to equation 860 of FIG. 8B, the M4 metric 308 value for the T1/T2 test case pair is the sum of the values of matrix 820 of FIG. 8A, i.e., the sum of ΔB1/B2(T1,T2), ΔB1/B3(T1,T2) and ΔB2/B3(T1,T2), divided by the number of entries (3) in matrix 820. Thus, in the example of FIGS. 8A-8B the M4 metric value for the T1/T2 test case pair, M4(T1,T2), is sixty-eight one-thousands (0.0034+0.0034+0=0.0068) divided by three (3), which equals twenty-three one-thousands (0.0023).

In an embodiment a fifth metric, M5, 310 is a def-use chain commonality comparison that measures def-use (definition/use) chain testing overlap between two test cases in a test suite. In an embodiment a def-use chain is a logic execution sequence in a block that defines and uses a variable. Referring to FIG. 4C, an exemplary def-use DU-1 chain 455 is shown as a portion of an execution sequence 440 for exemplary test block B2 410 of FIG. 4A. Action A5 442, conditional branch IF2 444 and action A7 448 demarcate the exemplary DU-1 chain 455. In the exemplary DU-1 chain 455 action A5 442 defines a variable x and sets x to an initial value of five, and action A7 448 uses the variable x to set a value for a second variable y.

Exemplary def-use DU-2 chain 460 is also shown in FIG. 4C as a portion of the execution sequence 440 for exemplary test block B2 410. Action A5 442, conditional branch IF2 444 and action A6 446 demarcate exemplary DU-2 chain 460. In the exemplary DU-2 chain 460 action A5 442 defines a variable x and sets x to an initial value of five, and action A6 446 uses the variable x to set a value for the second variable y.

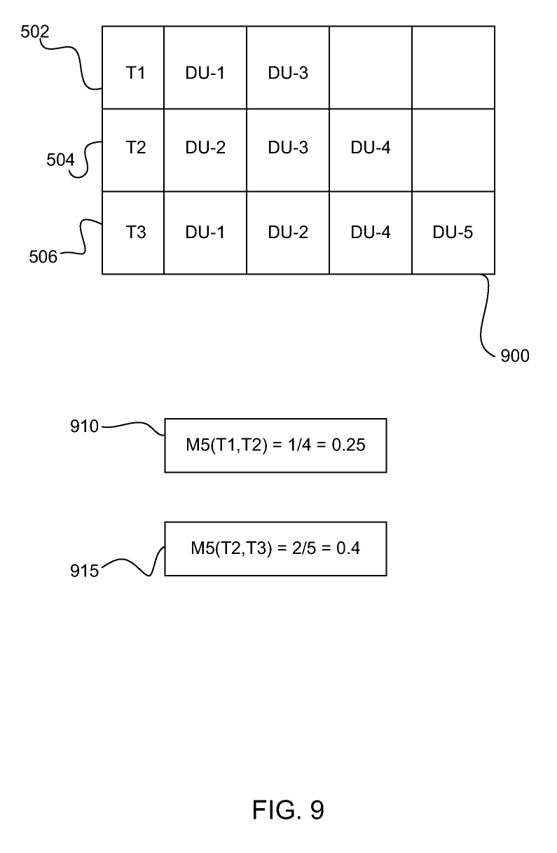

FIG. 9 is an example for determining an M5 metric 310 value for three exemplary tests, T1 502, T2 504, and T3 506, of a test suite. Chart 900 depicts exemplary def-use executions for each of tests T1 502, T2 504 and T3 506. In the example of FIG. 9 T1 502 executes def-use chains DU-1 and DU-3 of an exemplary software code under test. In the example of FIG. 9 T2 504 executes def-use chains DU-2, DU-3 and DU-4 and test T3 506 executes def-use chains DU-1, DU-2, DU-4 and DU-5.

In an embodiment the M5 metric 310 is calculated by adding the number of common def-use chains tested by a test case pair and dividing the sum by the total number of unique def-use chains tested by both test cases of the pair. In an embodiment the M5 metric 310 has no notion of sequencing or timing and for the M5 metric 310 it is of no consequence whether or not the test cases of a test case pair execute the common def-use chains in the same order or the same time interval.

In an embodiment the def-use chains executed by each test case of a test suite is statistically determined at the time the software code under test is instrumented.

Equation 910 of FIG. 9 is an exemplary calculation for the M5 metric 310 for the T1/T2 test case pair. In the example of FIG. 9 T1 502 and T2 504 both execute the DU-3 def-use chain and the DU-3 def-use chain is the only def-use chain executed by both of these test cases. Thus the numerator for the M5 metric 310 for the T1/T2 test case pair is one (1). In the example of FIG. 9 T1 502 and T2 504 execute a total of four (4) unique def-use chains, DU-1, DU-2, DU-3 and DU-4. Thus the denominator for the M5 metric 310 for the T1/T2 test case pair is four (4) and the M5 metric value for the T1/T2 test case pair is one (1) divided by (4) or one-quarter (0.25).

Equation 915 of FIG. 9 is an exemplary calculation for the M5 metric 310 for the T2/T3 test case pair. In the example of FIG. 9 T2 504 and T3 506 each execute def-use chains DU-2 and DU-4. Thus the numerator for the M5 metric 310 for the T2/T3 test case pair is two (2). Test cases T2 504 and T3 506 combined execute five unique def-use chains, DU-1, DU-2, DU-3, DU-4 and DU-5, and thus the denominator for the M5 metric 310 for the T2/T3 test case pair is five (5). The resultant exemplary M5 metric value for the T2/T3 test case pair shown in equation 915 is two (2) divided by five (5), which equals four-tenths (0.4).

As shown in FIG. 3, in an embodiment a sixth metric M6 312 is a data variance which measures the similarity, or diversity, of test cases with respect to the data values the test cases use for code variables. In an embodiment data variance is computed as the similarity of the number of times two test cases execute the same conditional branches, loops and/or blocks. In this embodiment counts are used to indirectly represent the data values of variables in the software code under test. In other embodiments where data variable values are collected at test run time the M6 312 metric can be calculated with the collected data variable values.

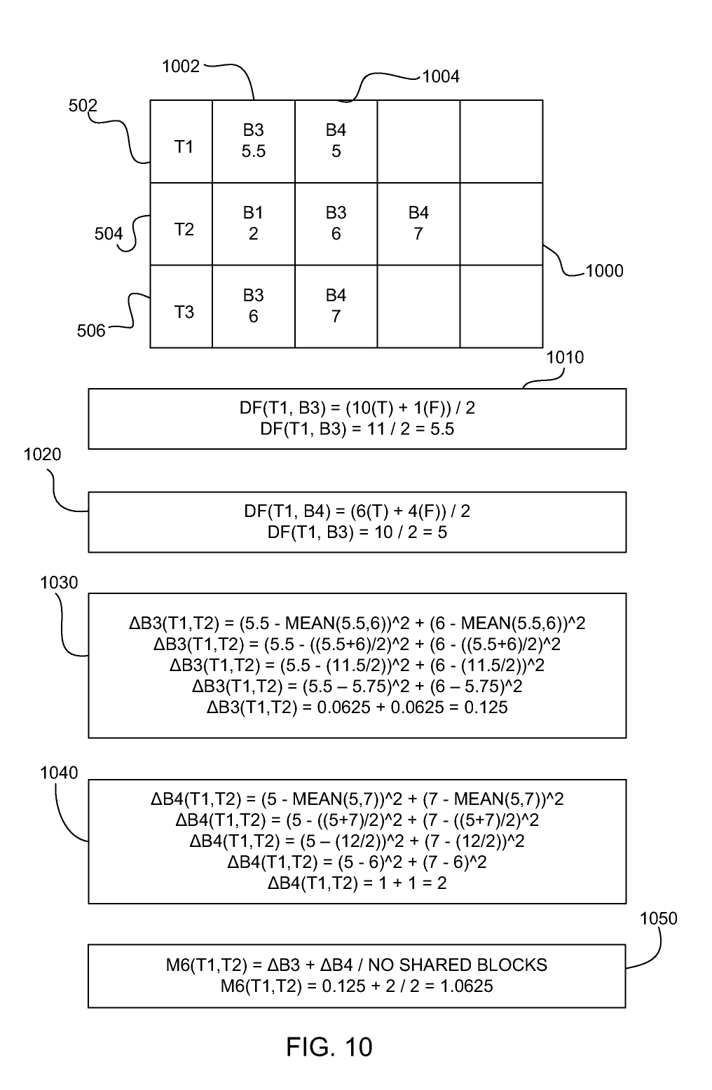

FIG. 10 is an example for generating an M6 metric 312 value for a test case pair. In FIG. 10 three exemplary tests, T1 502, T2 504, and T3 506, of a test suite have each executed blocks of a target binary, including block B3 408 of FIG. 4B. In an embodiment for each test case that executes a block a data flow, DF, value is calculated that provides a measurement of the data variable values set by the test case. In an embodiment a DF value for a test case is defined as the mean of the number of times a loop in a block is executed by the test case.

Exemplary data flow, DF, values are depicted in chart 1000 for the blocks executed by test cases T1 502, T2, 504 and T3 506. An exemplary DF value for test case T1 502 for block B3 is five and five-tenths (5.5) as shown by entry 1002 of chart 1000. An exemplary DF value for test case T1 502 for block B4 is five (5) as shown by entry 1004 of chart 1000.

Referring to equation 1010 of FIG. 10, as an example the data flow value, DF, is calculated for exemplary test case T1 502 for the conditional statement IF1 424 of block B3 408 in FIG. 4B. Assume for this example that test case T1 502 executes the true branch 432 of the conditional statement IF1 424 ten (10) times and the false branch 434 one (1) time. The

DF value for test case T1 502 for block B3, i.e., DF(T1,B3), is the average of the number of times each loop, i.e., the true loop and the false loop of the conditional statement IF1 424, in block B3 is executed by T1 502. As shown in equation 1010, DF(T1,B3) is the average of ten (10), for ten true loop executions, and one (1), for one false loop execution, which is five and five-tenths (5.5).

Equation 1020 is an example DF calculation for test case T1 502 for block B4. In this example assume that T1 502 executes the true branch of a conditional statement in block B4 six (6) times and the false branch of the same conditional statement four (4) times. The DF value for test case T1 502 for block B4, i.e., DF(T1,B4), is the average of the number of times each loop, i.e., the true loop and the false loop of the conditional statement in block B4, is executed by T1 502. As shown in equation 1020, DF(T1,B4) is the average of six (6), for six true loop executions, and four (4), for four false loop executions, which is five (5).

In an embodiment DF values are generated for each test case for each block with a loop executed by the test case. Chart 1000 shows exemplary DF values for blocks B1, B3 and B4 of a software program executed by test cases T1 502, T2 504 and T3 506.

In an embodiment the M6 metric 312 value for a test case pair is calculated by adding the variance of DF values for common blocks with loop statements executed by the test case pair and dividing by the number of common blocks with loop statements executed by the test cases.

Equation 1050 of FIG. 10 is an exemplary calculation for the M6 metric 312 for the test case pair T1/T2. In the example of FIG. 10 T1 502 and T2 504 both execute blocks B3 and B4 and both blocks B3 and B4 have loop statements. While T2 504 also executes the B1 block, T1 502 does not, and thus in an embodiment the DF value for T2 504 for B1 does not affect the M6 metric 312 value for the T1/T2 test case pair

As shown in the embodiment example of equation 1050 the M6 metric 312 value for T1/T2 is calculated by adding the variances of DF values for commonly executed blocks containing loop statements and dividing by the number of commonly executed blocks containing loop statements executed by the test case pair. Thus the M6 metric 312 value for the T1/T2 test case pair is the variance of the DF values for block B3, i.e., ΔB3, plus the variance of the DF values for block B4, i.e., ΔB4, divided by the number of commonly executed loop statement blocks, two (2).

In an embodiment the variance of DF values for a block is calculated by subtracting the mean of the DF values for each test case for the block from each DF value for each test case in the test case pair, squaring the result and summing each of the squared results. In other embodiments other statistical computations that quantify the diversity between DF values for a block for a test case pair are used.

Exemplary equation 1030 shows an embodiment calculation for the variance of DF values for block B3 for the test case pair T1/T2, i.e., ΔB3(T1,T2). As shown in FIG. 10, the mean, or average, of the DF values for the B3 block for T1/T2 is calculated and then squared. In the example of FIG. 10 the mean of the DF values for block B3 for T1/T2 is the sum of the DF values for block B3 for T1 502 and T2 504, i.e., the sum of five and five-tenths (5.5) and six (6) as shown in chart 1000, divided by the number of summed values, i.e., two (2). The resultant mean value, five and three-quarters (5.75), is subtracted from each of the CF values for T1 502 and T2 504 for block B3, i.e., five and five-tenths (5.5) and six (6). The results of the subtractions are then squared and summed, resulting in a variance of DF values for block B3 for T1/T2, i.e., ΔB3(T1,T2), of one hundred and twenty-five one-thousands (0.125).

Exemplary equation 1040 shows an embodiment calculation for the variance of DF values for block B4 for the test case pair T1/T2, i.e., ΔB4(T1,T2). As shown in FIG. 10 the mean of the DF values for the B4 block for T1/T2 is calculated and then squared. In the example of FIG. 10 the mean of the DF values for the B4 block for T1/T2 is the sum of the DF values for block B4 for T1 and T2, i.e., the sum of five (5) and seven (7) as shown in chart 1000, divided by the number of summed values, i.e., two (2). The resultant mean value, six (6), is subtracted from each of the DF values for T1 502 and T2 504 for block B4, i.e., five (5) and seven (7). The results of the subtractions are then squared and summed, resulting in a variance of DF values for block B4 for T1/T2, i.e., ΔB4(T1,T2), of two (2).

Referring again to equation 1050, the M6 metric 312 value for the T1/T2 test case pair is ΔB3(T1,T2) plus ΔB4(T1,T2) divided by the number of commonly executed loop statement blocks, B3 and B4, which is two (2). Thus, in the example of FIG. 10 the M6 metric value for the T1/T2 test case pair, M6(T1,T2), is two and one hundred and twenty-five one-thousands (2+0.125=2.125) divided by two (2), which equals one and six-hundred and twenty-five ten-thousands (1.0625).

Referring again to FIG. 1A, in an embodiment two signatures are generated for each test case pair of a test suite 112. In an embodiment each test case signature is an aggregate quantifiable metric that is used to identify the amount of similarity, or dissimilarity, of the test cases of a test case pair.

In an embodiment a signature is a weighted average of a subset of the k metrics generated for a test case pair. Thus, in an embodiment, once a set of metric values are established for a test case pair each metric is weighted, a subset of the weighted metrics are summed, and the result is divided by the number of added metrics, to define a signature for the test case pair.

In an embodiment each metric is given equal weight, or importance, and thus the weight assigned each metric is one (1). In an embodiment a metric can be disabled by assigning it a weight of zero (0). In other embodiments different weight values can be assigned each metric. In alternative embodiments each metric can be assigned a unique, individual weight value.

In an embodiment a first, variance, signature value for a test case pair is the weighted average of the M2 304, M4 308 and M6 312 metrics. An embodiment equation 1 is used for calculating a variance signature for a test case pair:

P₂M2+P₄M4+P₆M6/3 Equation 1

In Equation 1 Pₓ is the weight for the x^{th} metric and Mx is the x^{th} metric value for the test case pair. In an embodiment, as noted, P₂, P₄ and P₆ are all equal to one (1), and thus in an embodiment the variance signature for a test case pair is the average of the M2 304, M4 308 and M6 312 metric values for the test case pair.

In an embodiment a second, commonality, signature value for a test case pair is the weighted average of the M1 302, M3 306 and M5 310 metrics. An embodiment equation 2 is used for calculating a commonality signature for a test case pair:

P₁M1+P₃M3+P₅M5/3 Equation 2

In Equation 2 Pₓ is the weight for the x^{th} metric and Mx is the x^{th} metric value for the test case pair. In an embodiment, as noted, P₁, P₃ and P₅ are all equal to one (1), and thus in an embodiment the commonality signature for a test case pair is the average of the M1 302, M3 306 and M5 310 metric values for the test case pair.

In an embodiment Equation 1 and/or Equation 2 can be replaced by a learning technique, e.g., neural networks.

In an embodiment the calculated signatures for each test case pair of a test suite are stored and used to group the test cases into one or more clusters. In an embodiment each cluster has similar test cases of a test suite.

FIG. 11A depicts an exemplary table 1100 of variance and commonality signature values for the test case pairs of seven example test cases of a test suite. In the exemplary table 1100 the top number for any test case pair, e.g., values 1116, 1118 and 1124, are exemplary variance signature values for the indicated test case pair. In the exemplary table 1100 the bottom number for any test case pair, e.g., values 1126, 1128 and 1138, are exemplary commonality signature values for the indicated test case pair.

In an embodiment clustering methodology each test case of a test suite is initially assigned its own test cluster. Thus, initially each test case is its own cluster and a test suite has the same number of clusters as test cases. An initial, level one, test case clustering 1120 for exemplary test cases T1 1102, T2 1104, T3 1106, T4 1108, T5 1110, T6 1112 and T7 1114 of a test suite is shown in FIG. 11B

In an embodiment agglomerative hierarchical clustering using pre-calculated pair-wise similarity, i.e., test case pair signatures, is employed to cluster test cases. As noted, in an embodiment clusters are established and initially assigned one unique test case each. Thereafter, in an embodiment clusters are incrementally combined until an optimal clustering is defined. In an embodiment clustering can also, or alternatively, be finalized when a predefined number of clusters are generated. In an embodiment clustering can also, or alternatively, be finalized when a predefined number of clustering iterations has been performed and/or a predefined clustering time limit expires. In other alternative embodiments clustering can also, or alternatively, be finalized using additional and/or different criteria.

In an embodiment two clusters are deemed similar to cluster, or combine, if the similarity differential between them is less than or equal to a predefined variance threshold value and is greater than or equal to a predefined commonality threshold value. In an embodiment at a first level each cluster is a single test case and two clusters, or test cases, can be combined into a new cluster if the variance signature value for the test case pair is less than or equal to a predefined variance threshold and the commonality signature value for the test case pair is greater than or equal to a predefined commonality threshold.

In an embodiment at a secondary, level two, and beyond, e.g., a third level, etc., two clusters are combined if the variance signature value for each test case pair that would be included in the combined cluster is less than or equal to a predefined variance threshold value and the commonality signature value for each test case pair that would be included in the combined cluster is greater than or equal to a predefined commonality threshold value.

A secondary, level two, test case clustering 1130 for exemplary test cases T1 1102, T2 1104, T3 1106, T4 1108, T5 1110, T6 1112 and T7 1114 is shown in FIG. 11B. In the level two clustering 1130, T1 1102 and T3 1106 are combined into a new cluster 1132, T2 1104 and T4 1108 are combined into a new cluster 1134, T5 1110 and T6 1112 are combined into a new cluster 1136, and test case T7 1114 remains in its original cluster 1122. In an embodiment and the example of FIG. 11B the test case pair T1/T3 has a variance signature value less than or equal to a predefined variance threshold value and a commonality signature value greater than or equal to a predefined commonality threshold value. In an embodiment and the example of FIG. 11B the test case pair T2/T4 has a variance signature value less than or equal to the predefined variance threshold value and a commonality signature value greater than or equal to a predefined commonality threshold value. In an embodiment and the example of FIG. 11B the test case pair T5/T6 has a variance signature value less than or equal to the predefined variance threshold value and a commonality signature value greater than or equal to a predefined commonality threshold value.

In the example of FIG. 11B a third, level three, test case clustering 1140 has been generated for the exemplary test cases. In the level three clustering 1140, cluster 1132 and cluster 1134 are combined, and thus T1 1102, T3 1106, T2 1104 and T4 1108 are combined into a new cluster 1142. In an embodiment and the example of FIG. 11B each test case pair in the third level cluster 1142 has a variance signature value less than or equal to a predefined variance threshold value and a commonality signature value greater than or equal to a predefined commonality threshold value. Thus, in the example of FIG. 11B each test case pair that can be made from test cases T1 1102, T2 1104, T3 1106 and T4, 1108, i.e., test case pairs T1/T2, T1/T3, T1/T4, T2/T3, T2/T4 and T3/T4, has a variance signature value less than or equal to a predefined variance threshold value and a commonality signature value greater than or equal to a predefined commonality threshold value.

In the level three test clustering 1140 of FIG. 11B cluster 1136 remains the same, consisting of test cases T5 1110 and T6 1112, and cluster 1122 remains the same, consisting of test case T7 1114.

In an embodiment, once two clusters are combined at any one level, the newly combined clusters are no longer considered for clustering at that same level. Thus, for example, once T1 1102 and T3 1106 are combined in the second cluster level 1130 in an embodiment neither of these test cases are considered for combining with any other cluster at this second level 1130. As another example, once cluster 1132 and cluster 1134 are combined in the third cluster level 1140 in an embodiment neither of these clusters is considered for combining with any other cluster at this third level 1140.

In an embodiment the predefined variance and commonality threshold values for defining whether or not two clusters can be combined can be adjusted based on a user's needs. In an embodiment, the more relaxed the variance and commonality threshold values, i.e., the larger the variance threshold value and the smaller the commonality threshold value, the larger the clusters will generally be, i.e., the more test cases per cluster in general, and the less total number of clusters. Larger clusters can result in less test cases that may need to be run, reducing test time and effort.

In an embodiment a rigid variance threshold value is zero (0) and a rigid commonality threshold value is one (1), establishing that test cases in a cluster must test identical execution flow paths in the target binaries. In an embodiment a sensitive variance threshold value is two one-hundreds (0.02) and a sensitive commonality threshold value is ninety-five one-hundreds (0.95). In an embodiment a relaxed variance threshold value is five one-hundreds (0.05) and a relaxed commonality threshold value is nine-tenths (0.9). In other embodiments other values can be used for rigid, sensitive and relaxed threshold values and/or other labels can be applied to these same threshold values and/or other threshold values can be used.

FIG. 11C is an embodiment pseudo code algorithm 1150 for clustering. The embodiment pseudo code algorithm 1150 initially establishes a unique cluster for each test case in a test suite 1152 and the number of initial clusters is equal to the number of tests in the test suite 1154. In the embodiment algorithm 1150 clustering is performed while the optimal criterion for clustering can still be met, the number of clusters is not a predetermined cluster threshold size, e.g., k, and the number of iterations, or clustering levels, remains less than a predefined level threshold, e.g., x, 1156. In the embodiment algorithm 1150 the first criteria for the clustering algorithm to continue processing, optimal criterion can still be met, means that clustering can continue as long as there are still test case pairs whose signature values will allow for clustering given set variance and commonality threshold values.

In an aspect of the embodiment algorithm 1150 the variable k is set to ten (10), and thus, when ten or less clusters have been formed for a test suite the clustering algorithm 1150 terminates processing. In an aspect of the embodiment algorithm 1150 the variable x is set to fifty (50), and thus, when fifty iterations have processed the clustering algorithm terminates processing.

In any one iteration of the embodiment algorithm 1150, for each cluster(I) 1158, where I ranges from one (1) to the maximum number of existing clusters at the current cluster level, the clustering algorithm will find the closest cluster(J) 1160. The closest cluster(J) for a cluster(I) is the cluster(J) whose test cases, when combined in every test case pair combination with the test cases of cluster(I), have the smallest average variance signature value and largest average commonality signature value and whose variance signature values are equal to or less than a predefined variance threshold value and whose commonality signature values are equal to or greater than a predefined commonality threshold value. For example, refer to FIGS. 11A and 11B and assume a variance threshold value of two one-hundreds (0.02) and a commonality threshold value of ninety-five one-hundreds (0.95). In this example the variance signature value 1116 for the test case pair T1/T3 is the smallest variance signature value for any cluster containing T1 1102 at the initial cluster level 1120. In this example the commonality signature value 1126 for T1/T3 is the largest commonality signature value for any cluster containing T1 1102 at the initial cluster level 1120. Thus, T1 1102 and T3 1106 are combined 1162 into a new cluster 1132 at a second level 1130. In the embodiment algorithm 1150, because the initial cluster containing T1 1102 and the initial cluster containing T3 1106 are combined, or clustered, 1162 at this second level 1130, they are no longer considered for clustering at the first level 1120, and are both marked as used 1164. In an embodiment the number of total clusters is decremented, as two clusters have now been combined into one 1166.

Likewise in this example, the variance signature value 1118 for the test case pair T2/T4 is the smallest variance signature value for any cluster containing T2 1104 at the initial cluster level 1120. Additionally in this example the commonality signature value 1128 for T2/T4 is the largest commonality signature value for any cluster containing T2 1104 at the initial cluster level 1120. Thus, T2 1104 and T4 1108 are combined 1162 into a new cluster 1134 at the second level 1130. In the embodiment algorithm 1150, because the initial cluster containing T2 1104 and the initial cluster containing T4 1108 are combined 1162 at this second level 1130, neither T2 1104 nor T4 1108 are considered again for clustering at the first level 1120 and both are marked as used 1164. The number of total clusters is decremented, as two clusters have been combined into one 1166.

Finally, for the example of FIGS. 11A and 11B the variance signature value 1124 for the test case pair T5/T6 is the smallest variance signature value for any cluster containing T5 1110 at the initial cluster level 1120. In this example the commonality signature value 1138 for T5/T6 is the largest commonality signature value for any cluster containing T5 1110 at the initial cluster level 1120. T5 1110 and T6 1112 are therefore combined 1162 into a new cluster 1136 at the second level 1130. Again, in the embodiment algorithm 1150, because the initial clustering containing T5 1110 and the initial clustering containing T6 1112 are combined 1162 at this second level 1130, neither T5 1110 nor T6 1112 are considered again for clustering at the first level 1120 and both are marked as used 1164. The number of total clusters is decremented 1166.

At this juncture in the example, the only cluster that has not been marked as used at the initial cluster level 1120 is the initial cluster 1122 containing T7 1114. With the embodiment algorithm 1150 the cluster 1122 cannot be combined with any other cluster at the first level 1120 because the variance signature value of each T7 test case pair, i.e., T1/T7, T2/T7, T3/T7, T4/T7, T5/T7 and T6/T7, is greater than the exemplary variance similarity threshold value (0.02) set for the example. Moreover, even if there was a variance signature value for a test case pair containing T7 1114 that was less than or equal to the variance threshold value and a corresponding commonality signature value for the test case pair containing T7 1114 that was greater than or equal to the commonality threshold value, there are no clusters that are not marked as used at this current clustering level 1120. Therefore, T7 1114 remains in its original test cluster 1122 into the second clustering level 1130.

In the embodiment algorithm 1150 the number of clustering iterations is incremented 1168. In the example of FIGS. 11A and 11B the pseudo code 1150 will now execute at the second cluster level 1130.

In the example of FIGS. 11A and 11B at the second cluster level 1130 the closet cluster(J) to cluster(I) 1132 is cluster(J) 1134. In this example each test case pair of the test cases in cluster(I) 1132 and cluster(J) 1134, i.e., test case pairs T1/T2, T1/T3, T1/T4, T2/T3, T2/T4 and T3/T4, for test cases T1 1102, T2 1104, T3 1106 and T4 1108, have the smallest average variance signature values and the largest average commonality signature values, as shown in the chart 1100 of FIG. 11A, for any cluster(I) 1132/cluster(J) combination at this second level 1130. Additionally, each variance signature value for each test case pair in a combined cluster 1132/cluster 1134 is equal to or less than the exemplary variance threshold value (0.02) and each commonality signature value for each such test case pair is greater than or equal to the exemplary commonality threshold value (0.95). Thus, cluster 1132 and cluster 1134 are combined 1162 into a new cluster 1142 at the third level 1140. In the embodiment algorithm 1150, because clusters 1132 and 1134 are combined 1162 at the third cluster level 1140, these clusters are no longer considered for clustering at the second level 1130 and both are marked as used 1164. The number of total clusters is decremented, as two clusters have now been combined into one 1166.

At this juncture in the example the only remaining clusters that have not been marked as used is cluster 1136 containing T5 1110 and T6 1112 and cluster 1122 containing T7 1114. With the embodiment algorithm 1150 cluster 1122 cannot be combined with cluster 1136 because the variance signature value of each test case pair containing T7 1114 for this cluster combination, i.e., test case pairs T5/T7 and T6/T7, as shown in the chart 1100 of FIG. 11A, is greater than the exemplary variance threshold value (0.02) set for the example. Therefore, cluster 1136 and cluster 1122 remain as they are at this second iteration and into the third cluster level 1140.

The number of clustering iterations is incremented 1168, and in the example of FIGS. 11A and 11B, the pseudo code algorithm 1150 executes at the third cluster level 1140. At the third cluster level 1140 there are no clusters that can be combined where the combination of test cases for the newly combined cluster, when paired, will all have variance signature values less than the exemplary similarity threshold value (0.02) and commonality signature values greater than or equal to the exemplary commonality threshold value (0.95). Thus, in this example the optimal clustering has been reached and the clustering algorithm terminates 1170.

FIGS. 12A-12F illustrate an embodiment logic flow for generating clusters of similar test cases of a test suite. While the following discussion is made with respect to systems portrayed herein the operations described may be implemented in other systems. Further, the operations described herein are not limited to the order shown. Additionally, in other alternative embodiments more or fewer operations may be performed.

Referring to FIG. 12A, in an embodiment each test case is initially assigned its own cluster 1200, and thus there are initially the same number of clusters as test cases in a test suite. In an embodiment a variable, e.g., CN, is set to the current number of test cases, or clusters, 1201. In an embodiment the variable CN is used to determine if any clustering was performed at the current cluster level, or if the optimal clustering has been achieved for the test suite.

In an embodiment a first variable, e.g., x, is initialized to one (1), and a second variable, e.g., y, is initialized to two (2) 1202. In an embodiment variables x and y are used to keep track of the test case pairs that are being compared for possible clustering at the first, initial, clustering level. In an embodiment a variable, e.g., iteration, is initialized to one (1) 1202. In an embodiment the variable iteration is used to keep track of the number of clustering iterations performed.

In an embodiment a variable, e.g., tempc[c], is initialized to zero (0) 1202, a variable, e.g., tempc[sig1], is initialized to zero (0) 1202, and a variable, e.g., tempc[sig2], is initialized to zero (0) 1202. In an embodiment temp[c] is used to keep track of the optimal second test case for clustering with a first test case at a first, initial, clustering level. In an embodiment tempc[sig1] is used to keep track of the variance signature value of the first test case/temp[c] test case pair. In an embodiment tempc[sig2] is used to keep track of the commonality signature value for the first test case/temp[c] test case pair.

In an embodiment a set of variables or flags, one for each test case in a test suite, e.g., TC(x), are each initialized to indicate not used 1203. In an embodiment the set of TC(x) flags are used to keep track of whether a test case has already been clustered with another test case at the current clustering level.

In an embodiment at decision block 1204 a determination is made as to whether the variance signature value of a test case pair, e.g., a C(x)/C(y) test case pair of a test suite, is less than or equal to a pre-established variance threshold value, e.g., Δ1. If no, in an embodiment the variable y is incremented 1205 and, referring to FIG. 12B, at decision block 1223 a determination is made as to whether y is greater than the number of test cases in the test suite. At decision block 1223 the determination is whether the signatures for all test case pairs for a text case C(x) in a test suite have been analyzed to identify a test case to cluster with the test case C(x). If no, at decision block 1224 a determination is made as to whether the flag TC(y) for the newest test case to be paired with the C(x) test case for signature analysis indicates that the test case C(y) is used, i.e., that the test case C(y) has already been clustered with another test case at this current, initial, clustering level. If yes, in an embodiment y is incremented 1205 and at decision block 1223 a determination is again made as to whether y is now greater than the number of test cases in the test suite.

If at decision block 1224 the flag TC(y) for the newest test case to be paired with the C(x) test case for signature analysis indicates that C(y) is not used then in an embodiment control returns to decision block 1204 of FIG. 12A where a determination is made as to whether the variance signature value of the new test case pair, e.g., C(x)/C(y), is less than or equal to the variance threshold value.

In an embodiment, if at decision block 1204 the variance signature value for a current test case pair is less than or equal to a pre-established variance threshold value then at decision block 1206 a determination is made as to whether the commonality signature value of a test case pair, e.g., a C(x)/C(y) test case pair of a test suite, is greater than or equal to a pre-established commonality threshold value, e.g., Δ2. If no, in an embodiment the variable y is incremented 1205 and, referring to FIG. 12B, at decision block 1223 a determination is made as to whether y is greater than the number of test cases in the test suite.

In an embodiment, if at decision block 1206 the commonality signature value for a current test case pair is greater than or equal to a pre-established commonality threshold value then at decision block 1207 a determination is made as to whether the variable tempc[c] is still set to zero (0). In an embodiment if tempc[c] is set to zero at this time then no prior test case pair with test case C(x) had a variance signature value less than or equal to the variance threshold value and a commonality signature value greater than or equal to the commonality threshold value. In an embodiment, if tempc[c] is zero at decision block 1207 then tempc[c] is set to the C(y) test of the current C(x)/C(y) test case pair being analyzed 1208. In an embodiment the variable tempc[sig1] is set to the variance signature value of the current C(x)/C(y) test case pair being analyzed 1208. In an embodiment the variable tempc[sig2] is set to the commonality signature value of the current C(x)/C(y) test case pair being analyzed 1208.

Whether or not tempc[c] is zero at decision block 1207, in an embodiment at decision block 1209 a determination is made as to whether the variance signature value for the current C(x)/C(y) test case pair being analyzed is less than the variable tempc[sig1]. If yes, then in an embodiment at decision block 1210 a determination is made as to whether the commonality signature value for the current C(x)/C(y) test case pair being analyzed is greater than the variable tempc[sig2]. If yes, in an embodiment tempc[c] is set to the C(y) test case of the current C(x)/C(y) test case pair being analyzed 1208, tempc[sig1] is set to the variance signature value of the current C(x)/C(y) test case pair 1208, and tempc[sig2] is set to the commonality signature value of the current C(x)/C(y) test case pair 1208.

If at decision block 1209 the variance signature value for the current C(x)/C(y) test case pair being analyzed is not less than tempc[sig1] or at decision block 1210 the commonality signature value for the current C(x)/C(y) test case pair is not greater than tempc[sig2] then in an embodiment y is incremented 1205, and at decision block 1223 of FIG. 12B a determination is made as to whether y is now greater than the number of test cases in the test suite.

If at decision block 1223 of FIG. 12B y is greater than the number of test cases in the test suite, i.e., every test case pair combination for the C(x) test case has been analyzed at this first clustering level, then in an embodiment at decision block 1214 a determination is made as to whether the variable tempc[c] is still set to zero. If tempc[c] is zero at decision block 1214 there was no test case pair for the C(x) test case that had a variance signature value less than or equal to the variance threshold value and a commonality signature value greater than or equal to the commonality threshold value. In an embodiment x is incremented 1215. In an embodiment at decision block 1216 a determination is made as to whether x is greater than the number of test cases in the test suite.

If at decision block 1216 x is not greater than the number of test cases in the test suite then there are still test case pairs to be analyzed for clustering at the first clustering level. In an embodiment at decision block 1217 a determination is made as to whether the flag TC(x) for the newest C(x) test case to be paired for signature analysis indicates that test case C(x) is used, i.e., that C(x) has already been clustered with another test case at this current, initial, clustering level. If yes, in an embodiment x is incremented 1215 and at decision block 1216 a determination is again made as to whether x is now greater than the number of test cases in the test suite.

If at decision block 1217 the flag TC(x) indicates that the test case C(x) is not used then in an embodiment y is set to the value of x plus one (x+1) 1218. In an embodiment the variables tempc[c], tempc[sig1] and tempc[sig2] are reinitialized to zero (0) 1219. In an embodiment the current C(x) test case will be paired with all possible test cases, C(y), that have not already been clustered and for which the C(x)/C(y) test case pair has not already been analyzed for clustering at this first clustering level. In an embodiment at decision block 1223 a determination is made as to whether the now current value of y is greater than the number of test cases in the test suite.

If at decision block 1214 the value of tempc[c] is not zero than an optimal test case pair has been identified for clustering, i.e., the test case pair for the current C(x) test case with the smallest variance signature value that is less than or equal to the variance threshold value and with the largest commonality signature value that is greater than or equal to the commonality threshold value has been identified. In an embodiment the test case tempc[c] is clustered with the current C(x) test case 1220 into a new cluster C(x) that now contains the original C(x) test case and the tempc[c] test case.

In an embodiment TC(x) is set to used 1221 to indicate that the test case C(x) is no longer available for clustering at this initial clustering level. In an embodiment TC(tempc[c]) is set to used 1221 to indicate that the C(y) test case indicated by the variable tempc[c] and now clustered with the C(x) test case is no longer available for clustering at this initial clustering level.

In an embodiment the cluster C(tempc[c]) containing the test case C(y) that has now been added to the C(x) cluster is deleted 1222 and the number of existing clusters is decremented 1222. In an embodiment the next available C(x) test case is analyzed with the possible test case pairs to determine if the next available C(x) test case can be clustered. Thus, in an embodiment x is incremented 1215 and at decision block 1216 a determination is made as to whether x is now greater than the number of test cases in the test suite.

If at decision block 1216 x is greater than the number of test cases in the test suite then all test case pairs have been analyzed for clustering at this first clustering level. Referring to FIG. 12F, in an embodiment the iteration variable is incremented 1264. In an embodiment at decision block 1265 a determination is made as to whether the variable iteration is greater than a preset maximum number of clustering iterations. If yes, cluster processing ends 1268. If no, in an embodiment at decision block 1266 a determination is made as to whether the current number of clusters is less than or equal to a predefined maximum cluster threshold value. If yes, cluster processing ends 1268. If no, at decision block 1267 a determination is made as to whether the current number of clusters is equal to the variable CN. In an embodiment, at the start of processing of each clustering level the

If, however, at decision block 1267 the current number of clusters is not equal to CN then in an embodiment all conditions allow for the processing of another cluster level. Referring to FIG. 12C, in an embodiment a variable, e.g., x, is set to one (1) 1228 and a variable, e.g., y, is set to x plus one (x+1) 1228. In an embodiment a variable, e.g., n, is set to the number of test cases in the test suite and a variable, e.g., CN, is set to the current number of existing clusters for the test suite 1228. In an embodiment a variable, e.g., match, is set to no 1228. In an embodiment the variable match is used to keep track of whether or not a cluster pair has been identified for clustering at the current cluster level.

In an embodiment at decision block 1229 a determination is made as to whether cluster C(x) exits, as in an embodiment clusters are deleted when they are merged with another cluster. If cluster C(x) does not exist then in an embodiment x is incremented 1230, y is reset to a value of x plus one (x+1) 1230, and the variable match is set to no 1230.

In an embodiment at decision block 1231 a determination is made as to whether x is greater than the number of test cases, n, in the test suite. If x is greater than n then all clusters at the current clustering level have been analyzed for potential clustering and, in an embodiment, and referring to FIG. 12F, the variable iteration is incremented 1264.

If at decision block 1231 x is not greater than n then in an embodiment at decision block 1229 a determination is made as to whether cluster C(x) exists.

If at decision block 1229 it is determined that cluster C(x) exists then in an embodiment at decision block 1232 a determination is made as to whether cluster C(y) exists. If no, in an embodiment y is incremented 1233 and at decision block 1234 a determination is made as to whether y is greater than the number of test cases, n, in the test suite. If y is not greater than n then there are still cluster pairs for the current cluster C(x) to be analyzed for potential clustering, and in an embodiment at decision block 1232 a determination is made as to whether cluster C(y) exists.

If at decision block 1234 it is determined that y is greater than n then all cluster pairs for the current cluster C(x) have been analyzed at the current clustering level. In an embodiment at decision block 1235 a determination is made as to whether the variable match is set to yes. If match is set to yes then in an embodiment a cluster pair has been identified for clustering at the current cluster level and the cluster identified for combining with the current C(x) cluster, e.g., the mergec cluster, is clustered with the C(x) cluster 1236. In an embodiment the merged cluster mergec is deleted 1237 and the number of clusters is decremented 1237. In an embodiment x is incremented 1230, y is set to x plus one (x+1) 1230, and the variable match is reset to no 1230, for processing the next cluster C(x) for possible clustering at the current cluster level.

In an embodiment if the variable match is set to no at decision block 1235 then no cluster was identified for combining with the current C(x) cluster at the current clustering level. In an embodiment x is incremented 1230, y is set to x plus one (x+1) 1230, and the variable match is set to no 1230, for processing the next cluster C(x) for possible clustering.

If at decision block 1232 a determination is made that the cluster C(y) exists then in an embodiment, and referring to FIG. 12D, a variable, e.g., tempsig1, is set to zero (0) 1240 and a variable, e.g., tempsig2, is set to zero (0) 1240. In an embodiment the variable tempsig1 is used to calculate the variance signature average for each test case pair in a cluster C(x)/cluster C(y) pair. In an embodiment the variable tempsig2 is used to calculate the commonality signature average for each test case pair in a cluster C(x)/cluster C(y) pair. In an embodiment a variable, e.g., a, is initialized to one (1) 1241 and a variable, e.g., b, is initialized to one (1) 1241. In an embodiment the variable a is used to keep track of the test cases of the cluster C(x) and the variable b is used to keep track of the test cases of the cluster C(y).

In an embodiment at decision block 1242 a determination is made as to whether the variance signature for a test case pair containing a test case a, T(a), in cluster C(x) and a test case b, T(b), in cluster C(y) is less than or equal to a predetermined variance threshold value, e.g., Al. In an embodiment all test case pairs for the test cases in a cluster C(x) and a cluster C(y) must have a variance signature value that is less than or equal to the variance threshold value.

If at decision block 1242 the variance signature for the test case pair from the C(x)/C(y) cluster pair is not less than or equal to the variance threshold value then in an embodiment y is incremented 1243 and at decision block 1232 of FIG. 12C a determination is made as to whether the cluster C(y) exists.

If at decision block 1242 the variance signature for the test case pair from the C(x)/C(y) cluster pair is less than or equal to the variance threshold value then in an embodiment at decision block 1244 a determination is made as to whether the commonality signature for the test case pair containing the test case a, T(a), in cluster C(x) and the test case b, T(b), in cluster C(y) is greater than or equal to a predetermined commonality threshold value, e.g., Δ2. In an embodiment all test case pairs for the test cases in a cluster C(x) and a cluster C(y) must have a commonality signature value that is greater than or equal to the commonality threshold value.

If at decision block 1244 the commonality signature for the test case pair from the C(x)/C(y) cluster pair is not greater than or equal to the commonality threshold value then in an embodiment y is incremented 1243 and at decision block 1232 of FIG. 12C a determination is made as to whether the cluster C(y) exists.

If at decision block 1244 the commonality signature for the test case pair from the C(x)/C(y) cluster pair is greater than or equal to the commonality threshold value then in an embodiment the variance signature value for the test case pair is added to the value of the variable tempsig1 to produce a new value of tempsig1 1244. In an embodiment the commonality signature value for the test case pair is added to the value of the variable tempsig2 to produce a new value of tempsig2 1244. In an embodiment b is incremented 1246 for checking the next test case in the C(y) cluster with the current test case in the C(x) cluster.

At decision block 1247 a determination is made as to whether b is greater than the number of test cases in the cluster C(y). If no, at decision block 1242 a determination is made as to whether the variance signature for the test case pair containing the test case a, T(a), in cluster C(x) and test case b, T(b), in cluster C(y) is less than or equal to the variance threshold value.

If at decision block 1247 b is greater than the number of test cases in the cluster C(y) all test cases in the cluster C(y) have been processed for the current test case T(a) in the cluster C(x). In an embodiment a is incremented 1248 for checking the next test case in the C(x) cluster with all the test cases in the C(y) cluster. In an embodiment at decision block 1249 a determination is made as to whether a is greater than the number of test cases in the cluster C(x).

If at decision block 1249 a is not greater than the number of test cases in the cluster C(x) then there are still more test cases in cluster C(x) to be paired with test cases in cluster C(y) to determine if cluster C(x) and cluster C(y) can be combined. In an embodiment b is reset to one (1) 1250, for keeping track of the test cases in cluster C(y), and at decision block 1242 a determination is made as to whether the variance signature for a test case pair containing test case a, T(a), in cluster C(x) and test case b, T(b), in cluster C(y) is less than or equal to the variance threshold value.

If at decision block 1249 it is determined that a is greater than the number of test cases in the cluster C(x) then in an embodiment all test case pairs for the cluster C(x)/C(y) pair have been analyzed. In an embodiment, and referring to FIG. 12E, the value of the variable tempsig1 is divided by the number of test cases in cluster C(x) multiplied by the number of test cases in cluster C(y) 1254 to produce an average variance signature value for the cluster C(x)/C(y) pair. In an embodiment the value of the variable tempsig2 is divided by the number of test cases in cluster C(x) multiplied by the number of test cases in cluster C(y) 1254 to produce an average commonality signature value for the cluster C(x)/C(y) pair.

In an embodiment at decision block 1255 a determination is made as to whether the variable match is set to yes, indicating that another cluster pair containing the C(x) cluster is being considered for clustering at the current cluster level.

If at decision block 1255 match is not set to yes then no other cluster pairs that contain the C(x) cluster are currently being considered for clustering at the current cluster level and in an embodiment match is now set to yes 1257. In an embodiment a variable mergec is set to the cluster C(y) that meets the criteria for clustering with cluster C(x) 1258. In an embodiment a variable, e.g., mergesig1, is set to the variable tempsig1 1258 which is the average variance signature value for all test case pairs in the cluster C(x)/C(y) pair. In an embodiment a variable, e.g., mergesig2, is set to the variable tempsig2 1258 which is the average commonality signature value for all test case pairs in the cluster C(x)/C(y) pair.

In an embodiment y is incremented 1259 in order that another existing C(y) cluster can be analyzed with the current C(x) cluster for potential clustering at the current clustering level. In an embodiment, and referring again to FIG. 12C, at decision block 1232 a determination is made as to whether the cluster C(y) exists.

If at decision block 1255 match is set to yes, indicating that there is another cluster C(y) that meets the criteria for clustering with C(x) at the current cluster level, then in an embodiment at decision block 1256 a determination is made as to whether the average variance signature value, e.g., tempsig1, for the current C(x)/C(y) cluster pair is less than the average variance signature value, e.g., mergesig1, for another potential C(x)/C(y) cluster pair.

In an embodiment at decision block 1256, where there are two potential clusters C(y) to be combined with cluster C(x), the cluster C(y) that when paired with C(x) has the smallest average variance signature value is the more optimal cluster C(y) for combining with cluster C(x).

In an embodiment, if the currently processed C(y) cluster when paired with C(x) has the smaller average variance signature value, i.e., tempsig1 is less than mergesig1, then in an embodiment at decision block 1260 a determination is made as to whether the average commonality signature value, e.g., tempsig2, for the current C(x)/C(y) cluster pair is greater than the average commonality signature value, e.g., mergesig2, for another potential C(x)/C(y) cluster pair. In an embodiment at decision block 1260, where there are two potential clusters C(y) to be combined with cluster C(x), the cluster C(y) that when paired with C(x) has the largest average commonality signature value is the more optimal cluster C(y) for combining with cluster C(x).

In an embodiment, if the currently processed C(y) cluster when paired with C(x) has the larger average commonality signature value, i.e., tempsig2 is greater than mergesig2, then in an embodiment mergec is set to the current cluster C(y) 1258. In an embodiment mergesig1 is set to tempsig1, i.e., the average variance signature value for the C(x)/C(y) cluster 1258, and mergesig2 is set to tempsig2, i.e., the average commonality signature value for the C(x)/C(y) cluster 1258. In an embodiment, if the currently processed C(y) cluster when paired with C(x) does not have a smaller average variance signature value nor a larger average commonality signature value, i.e., tempsig1 is not less than mergesig1 and tempsig2 is not greater than mergesig2, then the prior processed C(y) cluster is a more optimal pairing for the C(x) cluster. In an embodiment y is incremented 1259 to process any other potential clusters C(y) for pairing with the current cluster C(x).

### Computing Device System Configuration

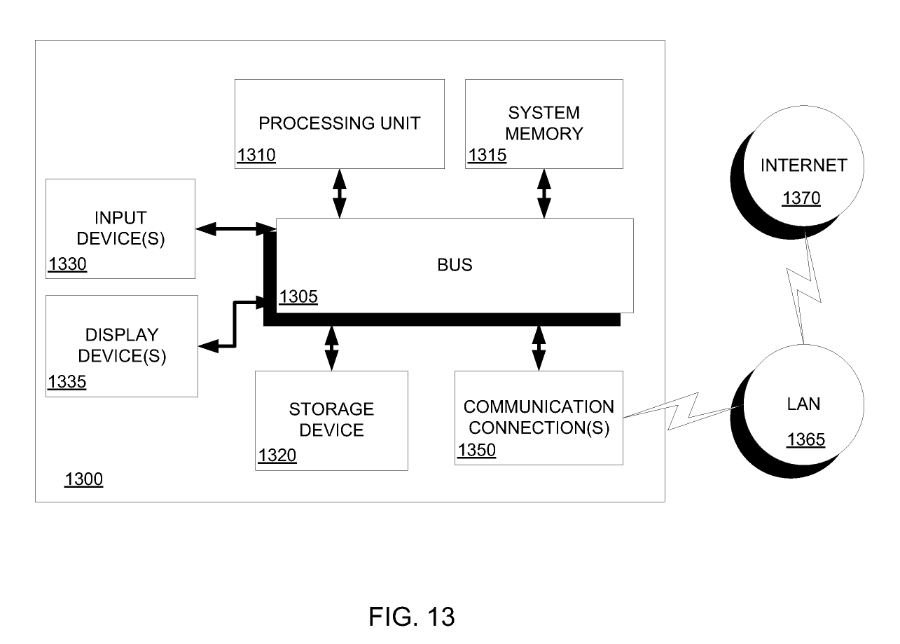

FIG. 13 is a block diagram that illustrates an exemplary computing device system 1300 upon which an embodiment can be implemented. The computing device system 1300 includes a bus 1305 or other mechanism for communicating information, and a processing unit 1310 coupled with the bus 1305 for processing information. The computing device system 1300 also includes system memory 1315, which may be volatile or dynamic, such as random access memory (RAM), non-volatile or static, such as read-only memory (ROM) or flash memory, or some combination of the two. The system memory 1315 is coupled to the bus 1305 for storing information and instructions to be executed by the processing unit 1310, and may also be used for storing temporary variables or other intermediate information during the execution of instructions by the processing unit 1310. The system memory 1315 often contains an operating system and one or more programs, and may also include program data.

In an embodiment, a storage device 1320, such as a magnetic or optical disk, is also coupled to the bus 1305 for storing information, including program code comprising instructions and/or data.

The computing device system 1300 generally includes one or more display devices 1335, such as, but not limited to, a display screen, e.g., a cathode ray tube (CRT) or liquid crystal display (LCD), a printer, and one or more speakers, for providing information to a computing device user. The computing device system 1300 also generally includes one or more input devices 1330, such as, but not limited to, a keyboard, mouse, trackball, pen, voice input device(s), and touch input devices, which a computing device user can use to communicate information and command selections to the processing unit 1310. All of these devices are known in the art and need not be discussed at length here.

The processing unit 1310 executes one or more sequences of one or more program instructions contained in the system memory 1315. These instructions may be read into the system memory 1315 from another computing device-readable medium, including, but not limited to, the storage device 1320. In alternative embodiments, hard-wired circuitry may be used in place of or in combination with software program instructions. The computing device system environment is not limited to any specific combination of hardware circuitry and/or software.

The term “computing device-readable medium” as used herein refers to any medium that can participate in providing program instructions to the processing unit 1310 for execution. Such a medium may take many forms, including but not limited to, storage media and transmission media. Examples of storage media include, but are not limited to, RAM, ROM, EEPROM, flash memory, CD-ROM, digital versatile disks (DVD), magnetic cassettes, magnetic tape, magnetic disk storage, or any other magnetic medium, floppy disks, flexible disks, punch cards, paper tape, or any other physical medium with patterns of holes, memory chip, or cartridge. The system memory 1315 and storage device 1320 of the computing device system 1300 are further examples of storage media. Examples of transmission media include, but are not limited to, wired media such as coaxial cable(s), copper wire and optical fiber, and wireless media such as optic signals, acoustic signals, RF signals and infrared signals.

The computing device system 1300 also includes one or more communication connections 1350 coupled to the bus 1305. The communication connection(s) 1350 provide a two-way data communication coupling from the computing device system 1300 to other computing devices on a local area network (LAN) 1365 and/or wide area network (WAN), including the World Wide Web, or Internet 1370. Examples of the communication connection(s) 1350 include, but are not limited to, an integrated services digital network (ISDN) card, modem, LAN card, and any device capable of sending and receiving electrical, electromagnetic, optical, acoustic, RF or infrared signals.

Communications received by the computing device system 1300 can include program instructions and program data. The program instructions received by the computing device system 1300 may be executed by the processing unit 1310 as they are received, and/or stored in the storage device 1320 or other non-volatile storage for later execution.

### CONCLUSION

While various embodiments are described herein, these embodiments have been presented by way of example only and are not intended to limit the scope of the claimed subject matter. Many variations are possible which remain within the scope of the following claims. Such variations are clear after inspection of the specification, drawings and claims herein. Accordingly, the breadth and scope of the claimed subject matter is not to be restricted except as defined with the following claims and their equivalents.

What is claimed is:

1. A method for the maintenance of a test suite comprising two or more test cases, the method comprising:
partitioning a software code under test into two or more blocks;
creating one or more target binaries by instrumenting one or more of the two or more blocks to allow for the gathering of test case execution profiles;
executing a set of test cases of the test suite wherein the set of test cases comprises two or more test cases and wherein the execution of a test case comprises generating a test case execution profile;
generating a metric value for each test comparison metric of a set of test comparison metrics for each test case pair of the set of test cases executed wherein a test case pair comprises two test cases from the set of test cases executed;
generating a signature for each test case pair of the set of test cases executed wherein the signature is generated using one or more of the metric values for the test case pair; and
grouping the test cases of the set of test cases executed into one or more clusters of test cases.

2. The method for the maintenance of a test suite of claim 1 wherein the set of test comparison metrics comprises a commonality comparison metric.

3. The method for the maintenance of a test suite of claim 1 wherein the set of test comparison metrics comprises six metrics comprising a commonality comparison metric, a control flow variance metric, a temporal variance metric, a temporal togetherness comparison metric, a def-use chaining comparison metric and a data variance metric.

4. The method for the maintenance of a test suite of claim 1 wherein generating a signature for each test case pair of the set of test cases executed comprises generating a variance signature for each test case pair of the set of test cases and wherein generating a variance signature for a test case pair comprises calculating an average comprised of a first set of metric values for the test case pair from a first subset of test comparison metrics, the method further comprising generating a commonality signature for each test case pair of the set of test cases executed wherein generating a commonality signature for a test case pair comprises calculating an average comprised of a second set of metric values for the test case pair from a second subset of test comparison metrics.

5. The method for the maintenance of a test suite of claim 1 further comprising storing the test case execution profiles generated when the set of test cases of the test suite is executed.

6. The method for the maintenance of a test suite of claim 1 wherein the signature generated for each test case pair is a variance signature comprised of an average of a set of weighted values wherein the set of weighted values comprise one or more weighted metric values for the test case pair wherein each weighted metric value for the test case pair is a metric value for the test case pair multiplied by a number indicating the weight of the metric.

7. The method for the maintenance of a test suite of claim 1 wherein grouping the test cases of the set of test cases executed into one or more clusters of test cases comprises combining two or more test cases of the set of test cases executed into a cluster if the signature values for each test case pair that can be formed from the two or more test cases are not greater than a predefined threshold value.

8. The method for the maintenance of a test suite of claim 1, further comprising:
identifying a pivot test case in each cluster;
using the pivot test case from each cluster to generate a minimum suite of test cases wherein the minimum suite is comprised of a smaller number of test cases than the test suite; and
using the minimum suite of test cases to test the software code under test when there are test time constraints.

9. The method for the maintenance of a test suite of claim 8, further comprising verifying the minimum suite of test cases by executing each test case of the minimum suite of test cases with target binaries that have known bugs.

10. The method for the maintenance of a test suite of claim 1 wherein grouping the test cases of the set of test cases into one or more clusters of test cases comprises:
initially assigning each test case of the set of test cases executed to its own cluster;
combining two test cases of the set of test cases executed at a first clustering level into a new cluster of two test cases if the two test cases comprise a test case pair with a signature value within a predefined threshold level and the signature value of the test case pair is the optimum signature value for any test case pair of the set of test cases executed that are not already combined into a cluster of two test cases at the first clustering level; and
combining two clusters at a second clustering level into a second level cluster if each pair of test cases for each combination of two test cases in the two clusters has a signature value within a predefined threshold level and the average signature value for the two clusters is the optimum average signature value for any cluster pair at the second clustering level that is comprised of two clusters that are not already combined at the second clustering level into a second level cluster, wherein the average signature value for two clusters is the average of the signature values for every pair of test cases from the two clusters.

11. A method for clustering test cases of a test suite, the method comprising:
generating a signature value for each pair of test cases from the test suite;
assigning each test case of the test suite to its own unique first level cluster;
combining two test cases at a first clustering level into a cluster of two test cases based on the signature value of the two test cases being within a predefined threshold level and comprising the optimum signature value for any pair of test cases of the test suite that has two test cases that are not already combined at the first clustering level; and
combining two clusters at a second clustering level into a second level cluster based on the signature values of each pair of test cases from the two clusters being within a predefined threshold level and the average signature value for the two clusters comprising the optimum average signature value for any cluster pair at the second clustering level that is comprised of two clusters that are not already combined at the second cluster level, wherein the average signature value for two clusters is an average of the signature values for every pair of test cases from the two clusters.

12. The method for clustering test cases of a test suite of claim 11, further comprising:
combining clusters of one or more test cases until there is no two clusters that can be combined because there is at least one signature value for a test case pair of two test cases of two clusters that is without the predefined threshold level;
combining clusters of one or more test cases until the number of clusters is within a predefined cluster threshold value; and
combining clusters of one or more test cases until the number of cluster levels processed is within a predefined iteration value.

13. The method for clustering test cases of a test suite of claim 12 wherein the predefined cluster threshold value is ten and wherein combining clusters of one or more test cases until the number of clusters is within a predefined threshold value comprises combining clusters of one or more test cases until the number of clusters is no longer greater than ten.

14. The method for clustering test cases from a test suite of claim 11 wherein generating a signature value for each pair of test cases of the test suite comprises calculating a signature value from a set of one or more metrics wherein each of the one or more metrics provides a quantifiable comparison measurement of the test coverage of the test cases of the test case pair.

15. The method for clustering test cases of a test suite of claim 14 wherein the set of one or more metrics is a set of six metrics.

16. The method for clustering test cases of a test suite of claim 14 wherein the set of one or more metrics comprises a commonality comparison metric, a control flow variance metric, a temporal variance metric, a temporal togetherness comparison metric, a def-use chaining metric and a data variance metric.

17. The method for clustering test cases of a test suite of claim 11, further comprising generating a second signature value for each pair of test cases from the test suite, wherein generating a signature value for each pair of test cases of the test suite comprises calculating an average of a first set of weighted values for a test case pair wherein the first set of weighted values comprise one or more weighted metric values for the test case pair wherein each of the one or more metric values is a value for a metric from a first subset of metrics that each provide a quantifiable measurement of an aspect of the delta test coverage for the test cases in a test case pair and a weighted metric value is the metric value multiplied by a number indicating the weight of the metric, and wherein generating a second signature value for each pair of test cases from the test suite comprises calculating an average of a second set of weighted values for a test case pair wherein the second set of weighted values comprise one or more weighted metric values for the test case pair wherein each of the one or more metric values is a value for a metric from a second subset of metrics that each provide a quantifiable measurement of an aspect of the delta test coverage for the test cases in a test case pair and a weighted metric value is the metric value multiplied by a number indicating the weight of the metric.

18. A computer-readable medium having computer-executable instructions stored thereon that when executed by a processor of a computer implement a method for test suite analysis wherein the test suite comprises two or more test cases, the computer-readable medium comprising:
computer-executable instructions for calculating a metric value for each metric of a set of metrics for each test case pair of the two or more test cases of the test suite that are executed with a software code under test wherein the set of metrics comprises one or more metrics and wherein each metric of the set of metrics provides an aspect of delta test coverage for a test case pair of test cases of the test suite and wherein a test case pair is comprised of two test cases from the two or more test cases of the test suite that are executed with the software code under test;
computer-executable instructions for generating a signature value for each test case pair wherein the signature value comprises an indication of the similarity of the test cases comprising the test case pair;
computer-executable instructions for combining the two or more test cases of the test suite into one or more clusters of test cases; and
computer-executable instructions for identifying a pivot test case in each of the one or more clusters of test cases.

19. The computer-readable medium of claim 18, further comprising computer executable instructions for generating a second signature value for each test case pair, wherein the signature value generated for a test case pair comprises an average of a first subset of metric values calculated for the test case pair, and wherein the second signature value for each test case pair comprises an average of a second subset of metric values calculated for the test case pair.

20. The computer-readable medium of claim 18, further comprising:
computer-executable instructions for identifying at least one redundant test case in the two or more test cases of the test suite executed with the software code under test wherein the software code under test comprises two or more logic paths and a redundant test case tests the same logic path as a second test case in the one or more test cases of the test suite; and
computer-executable instructions for assigning a new test case of the test suite to one of the one or more clusters of test cases using signature values calculated for the new test case paired with one or more of the two or more test cases of the test suite executed with the software code under test.
